(19) United States
(12) Patent Application Publication
(10) Pub. No.: US 2023/0214651 A1
(43) Pub. Date: Jul. 6, 2023

(54) ARTIFICIAL NEURAL NETWORK FOR DATA IMBALANCED REGRESSION AND METHOD FOR TRAINING SAME

(71) Applicant: Royal Bank of Canada, Toronto (CA)

(72) Inventors: Yu Gong, Burnaby (CA); Frederick Tung, North Vancouver (CA); Greg Mori, Vancouver (CA)

(21) Appl. No.: 18/091,244

(22) Filed: Dec. 29, 2022

Related U.S. Application Data
(60) Provisional application No. 63/295,661, filed on Dec. 31, 2021.

(51) Int. Cl. G06N 3/08

(52) U.S. Cl. CPC G06N 3/08

(57) ABSTRACT

An artificial neural network for data imbalanced regression and a method for training that network. A regression dataset is obtained that includes multiple pairs that respectively are made up of inputs and corresponding targets. The inputs are represented in a feature space and the targets are represented in a label space of continuous values. Label space similarities between the targets as represented in the label space are determined, and analogously feature space similarities between the inputs as represented in the feature space are determined. A loss may then be determined based on differences between rankings of the label space similarities and corresponding feature space similarities. That loss may be used to train an artificial neural network.

### CROSS-REFERENCE TO RELATED APPLICATIONS

The present application claims priority to U.S. provisional patent application No. 63/295,661 filed on Dec. 31, 2021, and entitled “Artificial Neural Network for Data Imbalanced Regression and Method for Training Same”, the entirety of which is hereby incorporated by reference herein.

### TECHNICAL FIELD

The present disclosure is directed at an artificial neural network for data imbalanced regression and a method for training that network.

### BACKGROUND

Skewed data distributions, where the plurality of the data instances are from a small number of labels, widely exist in the real world and pose challenges to known machine learning implementations. Although deep learning has made much progress and shown its potential in many application domains, imbalanced datasets often present practical difficulties, causing neural networks to exhibit undesirable bias towards the labels of the plurality and under-representing the remaining labels. Prior work has thoroughly studied how to improve network training on imbalanced data, such as via cost-sensitive learning, representation learning, and decoupled learning. However, previous attempts have almost exclusively focused on the task of imbalanced classification as opposed to regression.

### SUMMARY

According to a first aspect, there is provided a method comprising obtaining a regression dataset comprising multiple pairs, wherein the pairs respectively comprise inputs and corresponding targets, and wherein the inputs are represented in a feature space and the targets are represented in a label space; determining label space similarities between the targets as represented in the label space; determining feature space similarities between the inputs as represented in the feature space; determining a loss based on differences between the label space similarities and feature space similarities that correspond to each other; and training an artificial neural network based on the loss.

The loss may be based on differences between rankings of the label space similarities and rankings of the feature space similarities.

The label space similarities may be represented as a first pairwise similarity matrix obtained by applying a first similarity function in the label space across the targets, and the feature space similarities may be represented as a second pairwise similarity matrix obtained by applying a second similarity function in the feature space across the inputs.

The first and second similarity functions may differ.

The first similarity function may comprise negative absolute distance and the second similarity function may comprise a cosine similarity.

The loss based on the differences between the label space similarities and feature space similarities may be determined as [symbol] , in which [symbol] equals Σᵢ₌₁^{m} [symbol] (rk(S_{[i,:]}^{y}), rk(S_{[i,:]}^{z})), in which S^{y} denotes the first pairwise similarity matrix, S^{z} denotes the second pairwise similarity matrix, [i, :] denotes an ith row of the matrices, rk denotes a ranking function, and [symbol] penalizes differences between the pairwise similarity matrices.

[symbol] may determine mean squared error between rk(S_{[i,:]}^{y}) and rk(S_{[i,:]}^{z}).

Training the artificial neural network may comprise determining

$$\frac{\partial ℒ}{\partial a} = - \frac{1}{λ} ( rk ( a ) - rk ( {a}_{λ} ) ) ,$$

wherein

$${a}_{λ} = a + λ \frac{\partial ℒ}{\partial rk} ,$$

and wherein λ denotes interpolation strength and a denotes S_{[i,:]}^{y} or S_{[i,:]}^{z}.

The artificial neural network may be trained based on minimizing the loss.

The label space may be continuous (e.g., the label space may comprise continuous values, such as continuous numeric values comprising a continuous sequence selected from a number set, such as a continuous range of natural numbers, integers, rational numbers, real numbers, or complex numbers).

The regression dataset may be imbalanced.

The artificial neural network may be trained based on a total loss determined from the loss based on the differences between the label space similarities and feature space similarities and also from one or more additional losses respectively determined by applying one or more imbalanced learning techniques.

The one or more imbalanced learning techniques may comprise any one or more of re-weighting, two-stage training, and distribution smoothing.

The method may further comprise, after the training: obtaining a data point of a type corresponding to the feature space; and applying the artificial neural network to determine a label corresponding to the label space based on the data point.

According to another aspect, there is provided an artificial neural network trained in accordance with any of the foregoing aspects of the method or suitable combinations thereof.

According to another aspect, there is provided a method comprising obtaining a testing input represented in a feature space; inputting the input sample into an artificial neural network trained to determine a testing target comprising part of a label space corresponding to the feature space representation of the testing input, wherein the artificial neural network is trained using a regression dataset comprising multiple pairs respectively comprising training inputs and corresponding training targets, wherein the training inputs are represented in the feature space and the training targets are represented in the label space, and wherein the training is based on a loss based on differences between label space similarities and feature space similarities that correspond to each other, wherein the label space similarities are determined between the training targets as represented in the label space and the feature space similarities are determined between the training inputs as represented in the feature space; and storing the testing target.

The label space similarities may be represented as a first pairwise similarity matrix obtained by applying a first similarity function in the label space across the testing targets, and the feature space similarities may be represented as a second pairwise similarity matrix obtained by applying a second similarity function in the feature space across the testing inputs.

The first and second similarity functions may differ.

The first similarity function may comprise negative absolute distance and the second similarity function may comprise a cosine similarity.

The loss based on the differences between the label space similarities and feature space similarities may be determined as [symbol] , in which [symbol] comprises Σᵢ₌₁^{m} [symbol] (rk(S_{[i,:]}^{y}), rk(S_{[i,:]}^{z})), where S^{y} denotes the first pairwise similarity matrix, S^{z} denotes the second pairwise similarity matrix, [i, :] denotes an ith row of the matrices, rk denotes a ranking function, and [symbol] penalizes differences between the pairwise similarity matrices.

[symbol] may determine mean squared error between rk(S_{[i,:]}^{y}) and rk(S_{[i,:]}^{z}).

Training the artificial neural network may comprise determining,

$$\frac{\partial ℒ}{\partial a} = - \frac{1}{λ} ( rk ( a ) - rk ( {a}_{λ} ) ) ,$$

in which

$${a}_{λ} = a + λ \frac{\partial ℒ}{\partial rk} ,$$

and in which λ denotes interpolation strength and a denotes S_{[i,:]}^{y} or S_{[i,:]}^{z}.

The artificial neural network may be trained based on minimizing the loss.

The regression dataset may be imbalanced.

The artificial neural network may be trained based on a total loss determined from the loss based on the differences between the label space similarities and feature space similarities and also from one or more additional losses respectively determined by applying one or more imbalanced learning techniques.

The one or more imbalanced learning techniques may comprise any one or more of re-weighting, two-stage training, and distribution smoothing.

According to another aspect, there is provided a system comprising: a processor; a database that is communicatively coupled to the processor; and a memory that is communicatively coupled to the processor and that has stored thereon computer program code that is executable by the processor and that, when executed by the processor, causes the processor to perform any of the foregoing aspects of the method or suitable combinations thereof. For example, a regression dataset may be stored in the database, and the processor may retrieve the regression dataset from the database and train an artificial neural network using the regression dataset as described above. Additionally or alternatively, a testing input may be stored in the database, and the processor may retrieve the testing input from the database and use the testing input as input to an artificial neural network trained as described above in order to determine/infer the corresponding target.

According to another aspect, there is provided a non-transitory computer readable medium having stored thereon computer program code that is executable by a processor and that, when executed by the processor, causes the processor to perform any of the foregoing aspects of the method or suitable combinations thereof.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts operation of a ranking similarity regularizer for data imbalanced regression, according to an example embodiment.

FIG. 2 is a block diagram of a computer system that may be used to implement the example regularizer of FIG. 1, according to an example embodiment.

FIG. 3 is a flowchart depicting a method for training an artificial neural network to perform data imbalanced regression, according to an example embodiment.

FIGS. 4A-4C are graphs visualizing features extracted from a data set in which FIG. 4C is generated in accordance with an example embodiment of the regularizer.

FIGS. 5A-5E depict average label-space and feature-space ranking matrices under various training settings.

FIG. 6 depicts curves of feature similarity between the anchor and other labels from a balanced subset of a data set.

FIG. 7 shows graphs depicting the ability of an example embodiment of the regularizer to handle a zero-shot scenario, with a top graph of FIG. 7 graphing a training distribution and a bottom graph of FIG. 7 depicting relative performance of an example embodiment of the regularizer.

### DETAILED DESCRIPTION

Data imbalance poses a challenge in training deep neural networks. In at least some examples, data imbalance may refer to any situation in which data samples are non-uniformly distributed between labels; more generally, practically data imbalance refers to a situation in which the plurality of data samples come from a small proportion of labels. Unlike classification, in regression the labels are continuous, potentially boundless, and form a natural ordering. These distinct features of regression call for new techniques that leverage the additional information encoded in label space relationships. Accordingly, in at least some example embodiments, methods and systems herein are directed at implementing a ranking similarity regularizer for deep imbalanced regression, which encodes a prior that samples that are closer in label space should also be closer in feature space. In contrast to other distribution smoothing based approaches, at least some example embodiments capture both nearby and distant relationships: for a given data sample, those embodiments encourage the sorted list of its neighbors in label space to match the sorted list of its neighbors in feature space. At least some embodiments are complementary to known imbalanced learning methods, including re-weighting, two-stage training, and distribution smoothing, and as evidenced by the experiments described below lift the state-of-the-art performance on three imbalanced regression benchmarks: IMDB-WIKI-DIR, AgeDB-DIR, and STS-B-DIR.

Compared to classification, how to train deep neural networks to perform regression (“regression networks”) with imbalanced data is not yet as well understood. Unlike neural networks used for classification (“classification networks”) to determine discrete labels to model categorical distributions, regression networks aim to predict labels with continuous values. The continuity in label space makes deep imbalanced regression different from deep imbalanced classification. On the one hand, the target values can be infinite and boundless, which makes many methods designed for deep imbalanced classification untenable. On the other hand, the continuity in label space can also play a positive role by providing extra information about data instance relationships.

In regression, the prediction targets form a natural ordering. For example, for an age estimation, people may be ordered from youngest to oldest; for property valuation, properties may be ordered from cheapest to most expensive; for credit allocation to borrowers, credit may be ordered from the smallest credit facility to the largest. This natural ordering of labels may be used to regularize the representation learned by a neural network. For example, the network may be trained such that the feature representation for the face of a 21-year old is more similar to the representation for a 25-year old than for a 70-year-old. This intuition of preserving label space relationships in the learned feature space is the motivation behind recent smoothing-based regularization approaches to address the imbalanced data problem in regression, such as label distribution smoothing (LDS) and feature distribution smoothing (FDS), as described in Yang, Y., Zha, K., Chen, Y.-C., Wang, H., and Katabi, D., Delving into deep imbalanced regression in International Conference on Machine Learning (ICML), 2021 (“Yang et al.”), the entirety of which is hereby incorporated by reference herein. As an illustrative example of why preserving label space relationships helps with imbalanced regression, when Yang et al. trained vanilla models on an imbalanced age estimation dataset, they observed that the learned features of 0-6 year-olds, which have very few samples, were highly similar to the learned features of 30 year-olds, which have a large number of samples. (A “vanilla” model refers to a conventionally trained backbone neural network without any imbalanced learning methods, such as ResNet-50 for the IMDB-WIKI-DIR and AgeDB-DIR datasets discussed further below.) This proximity in feature space, despite the large difference in label space, is undesirable as it hinders generalization to unseen 0-6 year-olds.

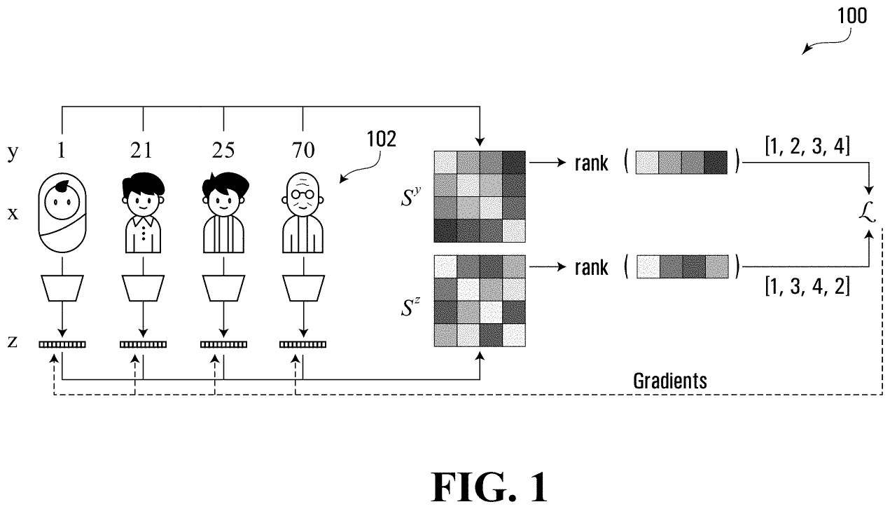

The ranking similarity regularizer in at least some example embodiments builds on this intuition and applies a stronger prior. An illustration of this is provided in FIG. 1, which depicts an example regularizer 100 for deep imbalanced regression that introduces a prior that items that are closer in label space should also be closer in feature space. Matrices S^{y} and S^{z} encode pairwise similarities in label space and feature space, respectively. For a given input sample, the regularizer 100 encourages the sorted list of its neighbors in label space to match the sorted list of its neighbors in feature space.

Using age estimation as an example, presume images of individuals 102 whose ages are 1, 21, 25, and 70. Denote their learned feature representations by z¹, z²¹, z²⁵, z⁷⁰, respectively. Smoothing-based regularization approaches would encourage, for example, z²¹ to be similar to z²⁵. However, it may also be desirable to have z²¹ to be somewhat similar to z¹, yet not as similar as z²¹ is to z²⁵. Let σ(⋅,⋅) denote a similarity function over vectors, such as the cosine similarity. For z²¹ to be somewhat similar to z¹, yet not as similar as z²¹ is to z²⁵, σ(z²¹, z²⁵)>σ(z²¹, z¹). Extending this, a complete desired ordering may be constructed based on the distance in label space (age) from the anchor z²¹:σ(z²¹,z²⁵)>σ(z²¹,z¹)>σ(z²¹,z⁷⁰). This construction can be repeated for the other samples as anchors. For example, using z²⁵ as anchor: σ(z²⁵, z²¹)>σ(z²⁵,z¹)>σ(z²⁵,z⁷⁰). In general, these conditions encode a prior that, for a given input sample, items that are closer in label space are also closer in feature space. In FIG. 1, S^{y} and S^{z} respectively encode pairwise similarities in label space and feature space, which are ranked and then used as input to a loss function [symbol] described further below.

Below, an overview of prior methods for deep imbalanced classification and regression is described. Following that, a ranking similarity regularizer 100 for deep imbalanced regression to at least some embodiments is described, with the regularizer 100 encoding a more “global” prior on label space/feature space relationships than state-of-the-art smoothing approaches: that prior captures not only nearby relationships but also distant relationships in label and feature space. Finally, experimental results applying that ranking similarity regularizer 100 on three public benchmarks for deep imbalanced regression are described. As used herein, a “testing” data instance, such as a testing input or testing target, refers to that data instance being used in conjunction with an artificial neural network performing regression at inference, while a “training” data instance refers to a data instance used in conjunction with the artificial neural network to train the network in order to perform that regression. A generic reference to a data instance may refer to using that instance in conjunction with testing and/or training, depending on the context.

### Prior Work: Imbalanced Classification

Prior work on learning with imbalanced data has predominantly focused on the imbalanced (or long-tailed) classification problem, where many classes have very few instances. Approaches can be grouped into data-based and model-based paradigms.

Data-based methods are usually associated with the input data. One common strategy is to over/under-sample the minority/majority classes: Synthetic Minority Oversampling Technique (SMOTE) linearly interpolates samples to synthesize new samples within one minority class; dynamic curriculum learning (DCL) initially performs random sampling, and then samples more minority classes based on the curriculum strategy; bilateral-branch network (BBN) conducts a conventional sampler for one branch and a reversed sampler for a re-balancing branch. Another data-based option is data augmentation: Mixup Shifted Label-Aware Smoothing (MiSLAS) uses data mixup in a decouple scheme and Remix proposes a re-balanced mixup version to enhance minority classes; implicit semantic data augmentation (ISDA) estimates the covariance matrices for each class to obtain semantic directions, which generates augmented samples; meta semantic augmentation (MetaSAug) extends ISDA to meta-learn the covariance matrices for each classes with class-balanced loss.

Model-based methods address the imbalance problem from a model perspective. Common strategies include cost-sensitive learning, representation learning, and two-stage (or decoupled) learning. Cost-sensitive learning focuses on adjusting loss values with adaptive penalties: class-balanced loss (CB) re-balances the loss values with a re-weighting term inversely proportional to the expected sample number of classes; focal loss inversely re-weights classes with the prediction probabilities based on the observation that it is usually harder for minority classes to achieve low loss values; equalization loss penalizes less on minority classes that serve as negative pairs of majority classes; Label distribution DisEntangling (LADE) involves a label distribution disentangling loss to disentangle from the long-tailed training distribution. Representation learning approaches focus on learning a less biased feature space from the imbalanced training data: range loss maximizes the inter-class distance, and minimizes the maximum intra-class distance; class rectification loss (CRL) enforces minority classes to have a larger degree of intra-class compactness and inter-class distances; and some hybrid networks adopt prototypical contrastive learning to enhance imbalanced classification. Two-stage or decoupling methods split the learning procedure into separate stages for representation learning and classifier learning. This is motivated by findings that data imbalance might not be an issue in learning high-quality representations, and with representations learned with the simplest instance-balanced (natural) sampling, it is possible to achieve strong long-tailed recognition ability by adjusting only the classifier. Similarly, label-aware smoothing may be used to handle different degrees of over-confidence for classes and improve classifier learning in the second stage.

### Prior Work: Imbalanced Regression

Regression aims to predict labels with continuous values. The continuity in label space makes imbalanced regression different from imbalanced classification. On the one hand, the target values can be infinite and boundless, which makes many methods designed for deep imbalanced classification untenable. On the other hand, the continuity in label space can also play a positive role by providing extra information about data instance relationships.

Early work on imbalanced regression attempted to re-sample the training set by synthesizing new samples for minority targets. To build meaningful connections between different labels and handle potential missing values, other approaches proposed to use kernel density estimation to perform smoothing on the target distribution. Label distribution smoothing (LDS) and DenseLoss share the similar idea of applying a Gaussian kernel to the empirical label density to estimate an “effective” label density distribution that takes the continuity of labels into account. Feature distribution smoothing (FDS), aiming to introduce continuity of the feature, performs distribution smoothing on the feature space by transferring the feature statistics (mean and covariance) between nearby target bins. However, these methods only account for the nearby label values, i.e. they encode a “local” prior. In contrast, at least some embodiments herein capture both nearby and distant relationships in label and feature space, encoding a more “global” prior.

Some methods for imbalanced classification can also be adapted to regression. For example, inspired by focal loss, a regression variant Focal-R re-weights the loss values by the L₁ error. As described below, at least some example embodiments of the ranking similarity regularizer 100 are complementary to Focal-R and other known imbalanced learning techniques.

### Example Ranking Similarity Regularizer

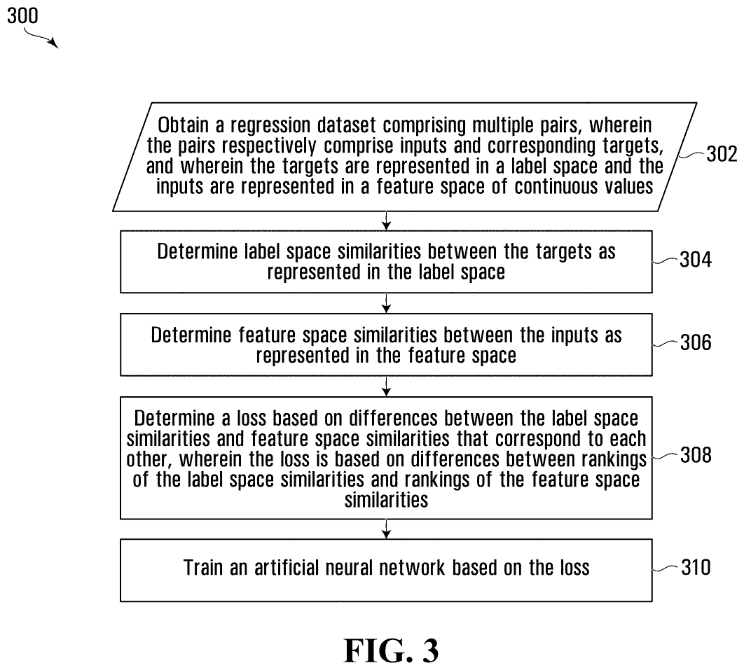

FIG. 3 depicts a method 300 for training an artificial neural network to perform data imbalanced regression, according to an example embodiment. Implementation of an example ranking similarity regularizer 100 is described below in conjunction with the depicted method 300.

In respect of an example embodiment of a ranking similarity regularizer 100, let a ∈ [symbol] ⁿ be an arbitrary vector of n real values. Let rk denote the ranking function, such that rk(a) is the permutation of {1, . . . , n} containing the rank (in sorted order) of each element in a. That is, the ith element in rk(a) is given by

rk(a)ᵢ=1+|{j: aⱼ>aᵢ}|. (1)

For example, if a=[9,5,11,6], then rk(a)=[2,4,1,3]. rk(a)₁ is 2 because a₁ is the second-largest (rank=2) element in a; rk(a)₂ is 4 because a₂ is the fourth-largest element in a; rk(a)₃ is 1 because a₃ is the largest element in a; finally, rk(a)₄ is 3 because a₄ is the third-largest element in a.

At block 302 of the method 300, a regression dataset is obtained. The regression dataset comprises multiple pairs, wherein the pairs respectively comprise inputs and corresponding targets, and wherein the targets are represented in a label space and the inputs are represented in a feature space. More particularly, in this example the regression dataset comprises a set of pairs (xᵢ, yᵢ), where xᵢ denotes the input and yᵢ the corresponding continuous-value target. z=f(x; θ) denotes the feature representation of x generated by a neural network parameterized by θ. This example ranking similarity regularizer 100 encourages alignment between the ranking of neighbors in label space (the y's) and the ranking of neighbors in feature space (the z's).

Accordingly, at block 304, the method 300 comprises determining label space similarities between the targets as represented in the label space. For example, consider a subset of pairs [symbol] ={(xᵢ, yᵢ)}, i=1, . . . m. Let S^{y}∈ [symbol] ^{m×m} be the pairwise similarity matrix obtained by applying similarity function σ^{y} in label space across all elements in [symbol] . In other words, the (i,j)th entry in S^{y} is given by

S_{i,j}^{y}=σ^{y}(yᵢ, yⱼ) (2)

which is the similarity between items i and j in label space. For continuous scalar labels, σ^{y} simply returns the negative absolute distance.

Analogously, at block 306 the method 300 comprises determining feature space similarities between the inputs as represented in the feature space. More particularly, in this example let S^{z}∈ [symbol] ^{m×m} be the pairwise similarity matrix obtained by applying similarity function σ^{z} in feature space. The (i,j)th entry in S^{z} is given by

S_{i,j}^{z}σ^{z}(zᵢ,zⱼ)=σ^{z}(f(xᵢ;θ),f(xⱼ;θ)), (3)

which is the similarity between items i and j in feature space. σ^{z} is a similarity function defined over vectors, such as the cosine similarity.

The method 300 also comprises at block 308 determining a loss based on a difference between the label space and feature space similarities that correspond to each other. Continuing with the above example, the loss for the example ranking similarity regularizer 100 with respect to subset [symbol] is then:

$${ℒ}_{RankSim} = {\sum }_{i = 1}^{m} ℓ ( rk ( {S}_{[ i , : ]}^{y} ) , rk ( {S}_{[ i , : ]}^{z} ) ) , \qquad ( 4 )$$

where [i,:] denotes the i^{th} row in the matrix and ranking similarity function [symbol] penalizes differences in the input vectors. Concretely, the mean squared error is adopted for [symbol] , which makes minimizing [symbol] equivalent to maximizing the Spearman correlation of the label space and feature space ranking vectors. An artificial neural network may be trained based on the loss at block 310. During neural network training, [symbol] is constructed from each batch; to reduce ties and boost the relative representation of infrequent labels, [symbol] is sampled from the current batch such that each label occurs at most once.

Eq. 4 implies that, given an input (xᵢ, yᵢ), it is desirable for the sorted list of its neighbors in label space to match the sorted list of its neighbors in feature space as closely as possible. When the match is exact, the loss is zero. Using the previous age estimation example, since σ^{y}(y¹¹,y⁹)>σ^{y}(y¹¹,y⁶)>σ^{y}(y¹¹,y⁵)>σ^{y}(y¹¹,y⁵⁵)>σ^{y}(y¹¹,y⁶⁰), where σ^{y} is the negative absolute distance, it is desirable for σ^{z}(z¹¹,z⁹)>σ^{z}(z¹¹, z⁶)>σ^{z}(z¹¹,z⁵)>σ^{z}(z¹¹,z⁵⁵)>σ^{z}(z¹¹,z⁶⁰), where σ^{z} is the cosine similarity, for example.

Eq. 4 is challenging to optimize because of the non-differentiability of the ranking operation. Ranking-based losses are piecewise constant functions of their input, and the gradient is zero almost everywhere: intuitively, small changes in the input to the ranking function do not always result in a change in the output ranking. However, the ranking operation can be recast as the minimizer of a linear combinatorial objective, as follows:

rk(a)=arg min_{π∈Π}_{ₙ}a·π, (5)

where Πₙ is the set of all permutations of {1, . . . ,n}. This expression allows an elegant method for efficient backpropagation through blackbox combinatorial solvers as described in Vlastelica, M., Paulus, A., Musil, V., Martius, G., and Rolinek, M., Differentiation of blackbox combinatorial solvers in International Conference on Learning Representations (ICLR), 2020, the entirety of which is hereby incorporated by reference herein. To obtain an informative gradient from the piecewise constant loss landscape, Vlastelica et al., ibid., implicitly constructs a family of piecewise affine continuous interpolation functions parameterized by a single hyperparameter λ>0 that trades off the informativeness of the gradient with fidelity to the original function. During the backward pass, instead of returning the true gradient (zero almost everywhere), the gradient of the continuous interpolation is determined and returned as follows:

$$\frac{\partial ℒ}{\partial a} = - \frac{1}{λ} ( rk ( a ) - rk ( {a}_{λ} ) ) , \qquad ( 6 )$$

where a_{λ} is constructed based on the incoming gradient information

$$\frac{\partial ℒ}{\partial rk}$$

by

$${a}_{λ} = a + λ \frac{\partial ℒ}{\partial rk} . \qquad ( 7 )$$

Backpropagation can accordingly be performed through the ranking operations in Eq. 4 at the cost of an additional call to rk (i.e., the call in Eq. 6 on the perturbed input). For clarity, the blackbox “solver” in this example embodiment is simply the ranking function rk, which can be implemented by sorting operations; there is no need for a general combinatorial solver.

The resulting example regularizer 100 is straightforward to implement, can be computed in closed form, and introduces only two hyperparameters: the interpolation strength λ, and the balancing weight γ on the regularization term in the overall network loss (i.e., adding [symbol] _{RankSim} to the other loss terms).

The regularizer 100 may be generally applicable to deep imbalanced regression applications. While FIG. 1 uses facial features as inputs in the feature space and numeric age as targets in the label space, other inputs and targets are possible. For example, the regularizer 100 may be applied to determine a target in the form of credit capacity of a borrower (i.e., a borrower's ability to repay a loan) based on an input comprising one or more, for example, of the borrower's income, debt-to-income ratio, number and/or types of existing loans, age, and employment. More generally and as another example, the inputs in the feature space may be non-numeric and the targets in the label space may be numeric (e.g., selected as continuous values from a suitable number system).

### Experiments

Experimental validation of an example embodiment of the ranking similarity regularizer 100 was performed on three public benchmarks for deep imbalanced regression: IMDB-WIKI-DIR, AgeDB-DIR and STS-B-DIR. Below, the benchmarks, metrics, and baselines used in the validation are described. Experimental results on the three benchmarks, including comparisons with known approaches, are then described.

IMDB-WIKI-DIR, AgeDB-DIR and STS-DIR are deep imbalanced regression benchmarks introduced by Yang et al. IMDB-WIKI-DIR and AgeDB-DIR are both in the domain of computer vision, while STS-B-DIR is in the domain of natural language processing.

IMDB-WIKI-DIR is an age estimation dataset consisting of face images and corresponding ages derived from IMDB-WIKI as described in Rothe, R., Timofte, R., and Gool, L. V., Deep expectation of real and apparent age from a single image without facial landmarks in International Journal of Computer Vision, 2016, the entirety of which is hereby incorporated by reference herein. IMDB-WIKI-DIR contains 191,509 samples in the training set, 11,022 samples in the validation set, and 11,022 samples in the test set. The validation and test sets are balanced, while the training set is imbalanced.

AgeDB-DIR is an age estimation from face images dataset derived from AgeDB as described in Moschoglou, S., Papaioannou, A., Sagonas, C., Deng, J., Kotsia, I., and Zafeiriou, S., Agedb: The first manually collected, in-the-wild age database in Conference on Computer Vision and Pattern Recognition Workshops (CVPRW), 2017, the entirety of which is hereby incorporated by reference herein. AgeDB-DIR contains 12,208 samples for training, 2,140 samples for validation, and 2,140 samples for testing. The validation and test sets are balanced.

STS-B-DIR is a natural language dataset derived from the Semantic Textual Similarity Benchmark as described in Cer, D., Diab, M., Agirre, E., Lopez-Gazpio, I., and Specia, L., SemEval-2017 task 1: Semantic textual similarity multilingual and crosslingual focused evaluation in International Workshop on Semantic Evaluation (SemEval-2017), 2017, the entirety of which is hereby incorporated by reference herein. STS-B-DIR was originally introduced to evaluate methods for measuring the meaning similarity between sentences. Annotators of the original dataset were asked to judge the meaning similarity of a pair of sentences on a scale of 0 to 5. For example, the meaning of “The bird is bathing in the sink” is basically equivalent to “Birdie is washing itself in the water basin” and may be assigned a 5 by an annotator. Sentence pairs are annotated by multiple annotators and assigned the average (continuous) similarity score. STS-B-DIR contains 5,249 sentence pairs for training, 1,000 pairs for validation, and 1,000 pairs for testing. The validation and test sets are balanced.

Following Yang et al. and common practice in imbalanced learning, overall results on the whole test set are reported, as well as on the subsets of many-shot region (bins with >100 training samples), medium-shot region (bins with 20 to 100 training samples), and few-shot region (bins with <20 training samples). In IMDB-WIKI-DIR and AgeDB-DIR, each bin is 1 year. In STS-B-DIR, the bin size is 0.1. Mean squared error (MSE, lower is better), mean absolute error (MAE, lower is better) and geometric mean (GM, lower is better) are reported on IMDB-WIKI-DIR and AgeDB-DIR. Mean squared error, mean absolute error, Pearson correlation (higher is better), and Spearman correlation (higher is better) are reported on STS-B-DIR.

The standard network architectures specified in Yang et al. were adopted: i.e. ResNet-50 for IMDB-WIKI-DIR and AgeDB-DIR, and BiLSTM+GloVe word embeddings for STS-B-DIR.

The example regularizer 100 is orthogonal to known imbalanced learning techniques, such as re-weighting as described in Lin, T.-Y., Goyal, P., Girshick, R., He, K., and Dollar, P., Focal loss for dense object detection, Transactions on Pattern Analysis and Machine Intelligence (T-PAMI), 2018 (“Lin et al.”), and two-stage (or decoupled) training as described in Kang, B., Xie, S., Rohrbach, M., Yan, Z., Gordo, A., Feng, J., and Kalantidis, Y., Decoupling representation and classifier for long-tailed recognition in International Conference on Learning Representations (ICLR), 2020 (“Kang et al.”), the entireties of both of which are hereby incorporated by reference herein, as well as to known distribution smoothing approaches for deep imbalanced regression such as in Yang et al. Detailed experimental analysis below verifies that, not only does the example regularizer 100 lift the known performance on the three benchmarks, it is in fact complementary to these well-established approaches.

### Experiments: IMDB-WIKI-DIR

Results on IMDB-WIKI-DIR are provided in Table 1, below. Baseline numbers are quoted from Yang et al. The best results for each method (Vanilla, Focal-R, RRT and SQINV) are marked with a single asterisk (*). The best results for each metric and data subset (entire column) are marked with a double asterisk (**). The regularizer 100 according to the example embodiment used for the experiment is denoted “Regularizer” in the leftmost column of the table.

TABLE 1
Experimental Results on the IMDB-WIKI-DIR Benchmark

| | Metrics | | | | | | | |
|---|---|---|---|---|---|---|---|---|
| | MAE ↓ | | | | GM ↓ | | | |
| Shot | All | Many | Med. | Few | All | Many | Med. | Few |
| Vanilla | 8.06 | 7.23 | 15.12 | 26.33 | 4.57 | 4.17 | 10.59 | 20.46 |
| Vanilla + LDS | 7.83 | 7.31 | 12.43 | 22.51 | 4.42 | 4.19 | 7.00 | 13.94 |
| Vanilla + FDS | 7.85 | 7.18 | 13.35 | 24.12 | 4.47 | 4.18 | 8.18 | 15.18 |
| Vanilla + LDS + FDS | 7.78 | 7.20 | 12.61 | 22.19 | 4.37 | 4.12 | 7.39 | 12.61 |
| Vanilla + Regularizer | 7.71 | 6.91* | 14.52 | 25.90 | 4.30 | 3.91* | 10.23 | 18.78 |
| Vanilla + LDS + Regularizer | 7.52* | 6.99 | 11.76* | 21.78* | 4.22* | 4.01 | 6.34* | 14.28 |
| Vanilla + FDS + Regularizer | 7.74 | 6.93 | 14.71 | 24.91 | 4.34 | 3.96 | 10.35 | 16.85 |
| Vanilla + LDS + FDS + Regularizer | 7.52* | 6.98 | 11.87 | 22.19 | 4.24 | 4.02 | 6.81 | 11.98** |
| Focal-R | 7.97 | 7.12 | 15.14 | 26.96 | 4.49 | 4.10 | 10.37 | 21.20 |
| Focal-R + LDS | 7.90 | 7.10 | 14.72 | 25.84 | 4.47 | 4.09 | 10.11 | 19.14 |
| Focal-R + FDS | 7.96 | 7.14 | 14.71 | 26.06 | 4.51 | 4.12 | 10.16 | 19.56 |
| Focal-R + LDS + FDS | 7.88 | 7.10 | 14.08 | 25.75 | 4.47 | 4.11 | 9.32 | 18.67 |
| Focal-R + Regularizer | 7.77 | 6.99 | 14.23 | 26.01 | 4.38 | 4.03 | 9.25 | 20.16 |
| Focal-R + LDS + Regularizer | 7.92 | 7.20 | 13.97* | 24.99 | 4.53 | 4.20 | 8.90* | 16.84 |
| Focal-R + FDS + Regularizer | 7.75 | 7.01 | 14.06 | 24.56* | 4.33* | 3.99* | 9.04 | 16.26* |
| Focal-R + LDS + FDS + Regularizer | 7.67* | 6.91* | 14.07 | 25.01 | 4.28 | 3.93 | 9.38 | 18.41 |
| RRT | 7.81 | 7.07 | 14.06 | 25.13 | 4.35 | 4.03 | 8.91 | 16.96 |
| RRT + LDS | 7.79 | 7.08 | 13.76 | 24.64 | 4.34 | 4.02 | 8.72 | 16.92 |
| RRT + FDS | 7.65 | 7.02 | 12.68 | 23.85 | 4.31 | 4.03 | 7.58 | 16.28 |
| RRT + LDS + FDS | 7.65 | 7.06 | 12.41 | 23.51 | 4.31 | 4.07 | 7.17 | 15.44 |
| RRT + Regularizer | 7.35** | 6.83 | 11.32** | 22.55 | 4.09 | 3.90 | 6.00** | 14.10 |
| RRT + LDS + Regularizer | 7.59 | 7.05 | 11.94 | 21.69** | 4.26 | 4.05 | 6.71 | 12.08* |
| RRT + FDS + Regularizer | 7.36 | 6.80** | 11.65 | 22.89 | 4.06** | 3.85 | 6.23 | 14.46 |
| RRT + LDS + FDS + Regularizer | 7.37 | 6.80** | 11.83 | 23.11 | 4.06** | 3.84** | 6.33 | 14.71 |
| SQInv | 7.87 | 7.24 | 12.44 | 22.76 | 4.47 | 4.22 | 7.25 | 15.10 |
| SQInv + LDS | 7.83 | 7.31 | 12.43 | 22.51 | 4.42 | 4.19 | 7.00 | 13.94 |
| SQInv + FDS | 7.83 | 7.23 | 12.60 | 22.37 | 4.42 | 4.20 | 6.93 | 13.48 |
| SQInv + LDS + FDS | 7.78 | 7.20 | 12.61 | 22.19 | 4.37 | 4.12 | 7.39 | 12.61 |
| SQInv + Regularizer | 7.43* | 6.86* | 11.85 | 23.17 | 4.15* | 3.93 | 6.59 | 13.40 |
| SQInv + LDS + Regularizer | 7.52 | 6.99 | 11.76* | 21.78* | 4.22 | 4.01 | 6.34* | 14.28 |
| SQInv + FDS + Regularizer | 7.45 | 6.88 | 12.01 | 22.79 | 4.15* | 3.91* | 6.92 | 14.03 |
| SQInv + LDS + FDS + Regularizer | 7.52 | 6.98 | 11.87 | 22.19 | 4.24 | 4.02 | 6.81 | 11.98** |
| Regularizer (best) vs. Vanilla | +0.71 | +0.43 | +3.80 | +4.64 | +0.51 | +0.33 | +4.59 | +8.48 |
| Regularizer (best) vs. Yang et al. (best) | +0.30 | +0.22 | +1.09 | +0.50 | +0.25 | +0.18 | +1.00 | +0.63 |

Metrics
MSE ↓

| Shot | All | Many | Med. | Few |
|---|---|---|---|---|
| Vanilla | 138.06 | 108.70 | 366.09 | 964.92 |
| Vanilla + LDS | 131.65 | 109.04 | 298.98 | 829.35 |
| Vanilla + FDS | 133.81 | 107.51 | 332.90 | 916.18 |
| Vanilla + LDS + FDS | 129.35 | 106.52 | 311.49 | 811.82 |
| Vanilla + Regularizer | 131.00 | 102.90 | 344.43 | 961.06 |
| Vanilla + LDS + Regularizer | 126.12* | 104.52 | 288.31 | 799.30** |
| Vanilla + FDS + Regularizer | 129.78 | 101.21* | 350.91 | 940.71 |
| Vanilla + LDS + FDS + Regularizer | 125.03 | 102.61 | 285.98* | 861.59 |
| Focal-R | 136.98 | 106.87 | 368.60 | 1002.90 |
| Focal-R + LDS | 132.81 | 105.62 | 354.37 | 949.03 |
| Focal-R + FDS | 133.74 | 105.35 | 351.00 | 958.91 |
| Focal-R + LDS + FDS | 132.58 | 105.33 | 338.65 | 944.92 |
| Focal-R + Regularizer | 130.86 | 102.82* | 342.70 | 967.78 |
| Focal-R + LDS + Regularizer | 132.16 | 105.16 | 337.55* | 927.23 |
| Focal-R + FDS + Regularizer | 132.42 | 105.45 | 338.61 | 918.23* |
| Focal-R + LDS + FDS + Regularizer | 130.20* | 102.94 | 338.73 | 923.43 |
| RRT | 132.99 | 105.73 | 341.36 | 928.26 |
| RRT + LDS | 132.91 | 105.97 | 338.98 | 916.98 |
| RRT + FDS | 129.88 | 104.63 | 310.69 | 890.04 |
| RRT + LDS + FDS | 129.14 | 105.92 | 306.69 | 880.13 |
| RRT + Regularizer | 123.05** | 101.15 | 276.36** | 874.56 |
| RRT + LDS + Regularizer | 126.89 | 104.94 | 289.65 | 806.93* |
| RRT + FDS + Regularizer | 123.08 | 100.51** | 282.97 | 881.95 |
| RRT + LDS + FDS + Regularizer | 123.61 | 100.64 | 287.16 | 889.62 |
| SQInv | 134.36 | 111.23 | 308.63 | 834.08 |
| SQInv + LDS | 131.65 | 109.04 | 298.98 | 829.35 |
| SQInv + FDS | 132.64 | 109.28 | 311.35 | 851.06 |
| SQInv + LDS + FDS | 129.35 | 106.52 | 311.49 | 811.82 |
| SQInv + Regularizer | 124.29* | 101.06* | 287.84 | 913.97 |
| SQInv + LDS + Regularizer | 126.12 | 104.52 | 288.31 | 799.30** |
| SQInv + FDS + Regularizer | 125.54 | 102.91 | 288.00 | 869.71 |
| SQInv + LDS + FDS + Regularizer | 125.03 | 102.61 | 285.98* | 861.59 |
| Regularizer (best) vs. Vanilla | +15.01 | +8.19 | +89.73 | +165.62 |
| Regularizer (best) vs. Yang et al. (best) | +6.09 | +4.12 | +22.62 | +12.52 |

Table 1 shows experimental results on the IMDB-WIKI-DIR benchmark. The baseline numbers are quoted from Yang et al. The table is grouped into four sections: vanilla (base network), Focal-R (focal loss as described in Lin et al. adapted to regression), regressor retraining (two-stage training as described in Kang et al. adapted to regression, abbreviated RRT), and square-root inverse frequency re-weighting (SQINV). Within each group, first shown are the results obtained by applying the known label and feature distribution smoothing methods (LDS and FDS, respectively) as described in Yang et al., both separately and in combination. The example regularizer 100 was integrated on top of each of these baselines.

Within each of the four sections, the best results are marked with an asterisk. The example regularizer 100 consistently obtains the best result within each section, across all metrics (MAE, GM, MSE) and test subsets (all, many-shot, medium-shot, few-shot). This outcome indicates that the example regularizer 100 is complementary to standard imbalanced learning techniques.

For each metric and test subset, the best overall result is marked with a double asterisk. The example regularizer 100 sets a new standard across all metrics and test subsets. For example, when combined with two-stage retraining (RRT), the example regularizer 100 achieves a leading mean absolute error of 7.35 on the overall test set. In the few-shot category, the example regularizer 100 combined with two-stage retraining (RRT) and label distribution smoothing (LDS) achieves a leading mean absolute error of 21.69.

### Experiments: AgeDB-DIR

Results on AgeDB-DIR are provided in Table 2, below. Baseline numbers are quoted from Yang et al. The best results for each method (Vanilla, Focal-R, RRT and SQINV) are marked with a single asterisk (*).The best results for each metric and data subset (entire column) are marked with a double asterisk (**). The regularizer 100 according to the example embodiment used for the experiment is denoted “Regularizer” in the leftmost column of the table.

TABLE 2
Experimental Results on the AgeDB-DIR Benchmark

| | Metrics | | | | | | | |
|---|---|---|---|---|---|---|---|---|
| | MAE ↓ | | | | GM ↓ | | | |
| Shot | All | Many | Med. | Few | All | Many | Med. | Few |
| Vanilla | 7.77 | 6.62 | 9.55 | 13.67 | 5.05 | 4.23 | 7.01 | 10.75 |
| Vanilla + LDS | 7.67 | 6.98 | 8.86 | 10.89 | 4.85 | 4.39 | 5.80 | 7.45 |
| Vanilla + FDS | 7.55 | 6.50 | 8.97 | 13.01 | 4.75 | 4.03 | 6.42 | 9.93 |
| Vanilla + LDS + FDS | 7.55 | 7.01 | 8.24 | 10.79 | 4.72 | 4.36 | 5.45 | 6.79* |
| Vanilla + Regularizer | 7.13 | 6.51 | 8.17 | 10.12* | 4.48 | 4.01 | 5.27 | 6.79* |
| Vanilla + LDS + Regularizer | 6.99* | 6.38* | 7.88 | 10.23 | 4.40* | 3.97* | 5.30 | 6.93 |
| Vanilla + FDS + Regularizer | 7.33 | 6.49 | 8.53 | 11.98 | 4.82 | 4.19 | 6.16 | 8.99 |
| Vanilla + LDS + FDS + Regularizer | 7.14 | 6.61 | 7.83* | 10.30 | 4.52 | 4.12 | 5.20 | 7.25 |
| Focal-R | 7.64 | 6.68 | 9.22 | 13.00 | 4.90 | 4.26 | 6.39 | 9.52 |
| Focal-R + LDS | 7.56 | 6.67 | 8.82 | 12.40 | 4.82 | 4.27 | 5.87 | 8.83 |
| Focal-R + FDS | 7.65 | 6.89 | 8.70 | 11.92 | 4.83 | 4.32 | 5.89 | 8.04 |
| Focal-R + LDS + FDS | 7.47 | 6.69 | 8.30 | 12.55 | 4.71 | 4.25 | 5.36 | 8.59 |
| Focal-R + Regularizer | 7.15 | 6.45 | 7.97 | 11.50 | 4.53 | 4.10 | 5.10 | 8.50 |
| Focal-R + LDS + Regularizer | 7.25 | 6.40 | 8.71 | 11.24 | 4.58 | 4.02 | 5.99 | 7.52* |
| Focal-R + FDS + Regularizer | 7.25 | 6.72 | 7.86* | 10.58* | 4.54 | 4.22 | 4.84** | 7.57 |
| Focal-R + LDS + FDS + Regularizer | 7.09* | 6.17** | 8.71 | 11.68 | 4.46* | 3.85** | 5.76 | 8.78 |
| RRT | 7.74 | 6.98 | 8.79 | 11.99 | 5.00 | 4.50 | 5.88 | 8.63 |
| RRT + LDS | 7.72 | 7.00 | 8.75 | 11.62 | 4.98 | 4.54 | 5.71 | 8.27 |
| RRT + FDS | 7.70 | 6.95 | 8.76 | 11.86 | 4.82 | 4.32 | 5.83 | 8.08 |
| RRT + LDS + FDS | 7.66 | 6.99 | 8.60 | 11.32 | 4.80 | 4.42 | 5.53 | 6.99 |
| RRT + Regularizer | 7.11 | 6.53 | 8.00 | 10.04 | 4.52 | 4.19 | 5.05* | 6.77* |
| RRT + LDS + Regularizer | 6.94* | 6.43* | 7.54** | 10.10 | 4.37* | 3.97* | 5.11 | 7.05 |
| RRT + FDS + Regularizer | 7.11 | 6.55 | 7.99 | 10.02* | 4.49 | 4.13 | 5.13 | 6.85 |
| RRT + LDS + FDS + Regularizer | 7.13 | 6.54 | 8.07 | 10.12 | 4.55 | 4.18 | 5.20 | 6.87 |
| SQInv | 7.81 | 7.16 | 8.80 | 11.20 | 4.99 | 4.57 | 5.73 | 7.77 |
| SQInv + LDS | 7.67 | 6.98 | 8.86 | 10.89 | 4.85 | 4.39 | 5.80 | 7.45 |
| SQInv + FDS | 7.69 | 7.10 | 8.86 | 9.98 | 4.83 | 4.41 | 5.97 | 6.29** |
| SQInv + LDS + FDS | 7.55 | 7.01 | 8.24 | 10.79 | 4.72 | 4.36 | 5.45 | 6.79 |
| SQInv + Regularizer | 6.91** | 6.34* | 7.79* | 9.89 | 4.28** | 3.92* | 4.88* | 6.89 |
| SQInv + LDS + Regularizer | 6.99 | 6.38 | 7.88 | 10.23 | 4.40 | 3.97 | 5.30 | 6.90 |
| SQInv + FDS + Regularizer | 7.02 | 6.49 | 7.84 | 9.68** | 4.53 | 4.13 | 5.37 | 6.89 |
| SQInv + LDS + FDS + Regularizer | 7.03 | 6.54 | 7.68* | 9.92 | 4.45 | 4.07 | 5.23 | 6.35 |
| Regularizer (best) vs. Vanilla(best) | +0.86 | +0.45 | +2.01 | +3.99 | +0.77 | +0.38 | +2.17 | +4.40 |
| Regularizer (best) vs. Yang et al. (best) | +0.56 | +0.33 | +0.70 | +1.11 | +0.43 | +0.18 | +0.52 | −0.06 |

Metrics
MSE ↓

| Shot | All | Many | Med. | Few |
|---|---|---|---|---|
| Vanilla | 101.60 | 78.40 | 138.52 | 253.74 |
| Vanilla + LDS | 102.22 | 83.62 | 128.73 | 204.64 |
| Vanilla + FDS | 98.55 | 75.06 | 123.58 | 235.70 |
| Vanilla + LDS + FDS | 99.46 | 84.10 | 112.20 | 209.27 |
| Vanilla + Regularizer | 87.45 | 71.84 | 111.41 | 168.61 |
| Vanilla + LDS + Regularizer | 84.14* | 71.72 | 98.59* | 161.48* |
| Vanilla + FDS + Regularizer | 90.09 | 69.90* | 112.69 | 205.12 |
| Vanilla + LDS + FDS + Regularizer | 86.88 | 74.39 | 99.80 | 169.09 |
| Focal-R | 101.26 | 77.03 | 131.81 | 252.47 |
| Focal-R + LDS | 98.80 | 77.14 | 125.53 | 229.36 |
| Focal-R + FDS | 100.14 | 80.97 | 121.84 | 221.15 |
| Focal-R + LDS + FDS | 96.70 | 76.11 | 115.86 | 238.25 |
| Focal-R + Regularizer | 86.67* | 69.57 | 105.10* | 197.15 |
| Focal-R + LDS + Regularizer | 89.54 | 69.87 | 118.84 | 194.34* |
| Focal-R + FDS + Regularizer | 90.12 | 76.69 | 105.55 | 175.18 |
| Focal-R + LDS + FDS + Regularizer | 87.12 | 66.01* | 120.10 | 195.35 |
| RRT | 102.89 | 83.37 | 125.66 | 224.27 |
| RRT + LDS | 102.63 | 83.93 | 126.01 | 214.66 |
| RRT + FDS | 102.09 | 84.49 | 122.89 | 224.05 |
| RRT + LDS + FDS | 101.74 | 83.12 | 121.08 | 210.78 |
| RRT + Regularizer | 86.93 | 72.11* | 108.08 | 168.41 |
| RRT + LDS + Regularizer | 82.98* | 72.49 | 91.24** | 159.24* |
| RRT + FDS + Regularizer | 86.93 | 72.36 | 107.90 | 166.55 |
| RRT + LDS + FDS + Regularizer | 87.28 | 72.20 | 109.19 | 169.16 |
| SQInv | 105.14 | 87.21 | 127.66 | 212.30 |
| SQInv + LDS | 102.22 | 83.62 | 128.73 | 204.64 |
| SQInv + FDS | 101.67 | 86.49 | 129.61 | 167.75 |
| SQInv + LDS + FDS | 99.46 | 84.10 | 112.20 | 209.27 |
| SQInv + Regularizer | 82.10** | 68.60** | 102.61 | 152.84 |
| SQInv + LDS + Regularizer | 84.14 | 71.72 | 98.59 | 161.48 |
| SQInv + FDS + Regularizer | 83.51 | 71.99 | 99.14 | 149.05** |
| SQInv + LDS + FDS + Regularizer | 84.96 | 74.27 | 93.64* | 161.92 |
| Regularizer (best) vs. Vanilla(best) | +19.50 | +9.80 | +47.28 | +104.69 |
| Regularizer (best) vs. Yang et al. (best) | +14.60 | +6.46 | +20.96 | +55.59 |

Table 2 shows experimental results on the AgeDB-DIR benchmark, following the same structure as IMDB-WIKI-DIR above. Comparing within each section (vanilla, Focal-R, RRT, SQINV), the example regularizer 100 obtains the best result in 47 out of the 48 combinations of metric (MAE, GM, MSE) and test subset (all, many-shot, medium-shot, few-shot), again demonstrating that the example regularizer 100 is complementary to standard imbalanced learning techniques. Overall, the example regularizer 100 sets a new standard on 11 out of 12 metric-subset combinations. The example regularizer 100 outperforms the baselines in both settings. For example, when combined with square-root inverse frequency re-weighting, the example regularizer 100 achieves a leading mean absolute error of 6.91 on the overall test set. In the few-shot setting, the example regularizer 100 with square-root inverse frequency re-weighting and feature distribution smoothing as described in Yang et al. achieves a leading mean absolute error of 9.68.

### Experiments: STS-B-DIR

Results on STS-B-DIR are provided in Table 3, below. Baseline numbers are quoted from Yang et al. The best results for each method (Vanilla, Focal-R, RRT and SQINV) are marked with a single asterisk (*). The best results for each metric (entire column) are marked with a double asterisk (**). The regularizer 100 according to the example embodiment used for the experiment is denoted “Regularizer” in the leftmost column of the table.

TABLE 3
Experimental Results on the STS-B-DIR Benchmark

| | Metrics | | | | | | | |
|---|---|---|---|---|---|---|---|---|
| | MSE ↓ | | | | MAE ↓ | | | |
| Shot | All | Many | Med. | Few | All | Many | Med. | Few |
| Vanilla | 0.974 | 0.851 | 1.520 | 0.984 | 0.794 | 0.740 | 1.043 | 0.771 |
| Vanilla + LDS | 0.914 | 0.819 | 1.319 | 0.955 | 0.773 | 0.729 | 0.970 | 0.772 |
| Vanilla + FDS | 0.916 | 0.875 | 1.027 | 1.086 | 0.767 | 0.746 | 0.840 | 0.811 |
| Vanilla + LDS + FDS | 0.907 | 0.802** | 1.363 | 0.942 | 0.766 | 0.718** | 0.986 | 0.755 |
| Vanilla + Regularizer | 0.873* | 0.908 | 0.767** | 0.705 | 0.749* | 0.755 | 0.737 | 0.695 |
| Vanilla + LDS + Regularizer | 0.889 | 0.911 | 0.849 | 0.690 | 0.755 | 0.762 | 0.758 | 0.638** |
| Vanilla + FDS + Regularizer | 0.884 | 0.924 | 0.767** | 0.685* | 0.755 | 0.769 | 0.736* | 0.653 |
| Vanilla + LDS + FDS + Regularizer | 0.903 | 0.908 | 0.911 | 0.804 | 0.761 | 0.759 | 0.786 | 0.712 |
| Focal-R | 0.951 | 0.843 | 1.425 | 0.957 | 0.790 | 0.739 | 1.028 | 0.759 |
| Focal-R + LDS | 0.930 | 0.807* | 1.449 | 0.993 | 0.781 | 0.723* | 1.031 | 0.801 |
| Focal-R + FDS | 0.920 | 0.855 | 1.169 | 1.008 | 0.775 | 0.743 | 0.903 | 0.804 |
| Focal-R + LDS + FDS | 0.940 | 0.849 | 1.358 | 0.916 | 0.785 | 0.737 | 0.984 | 0.732 |
| Focal-R + Regularizer | 0.887 | 0.889 | 0.918 | 0.745 | 0.763 | 0.757 | 0.805 | 0.719 |
| Focal-R + LDS + Regularizer | 0.872* | 0.887 | 0.847 | 0.718* | 0.752* | 0.751 | 0.770 | 0.701 |
| Focal-R + FDS + Regularizer | 0.913 | 0.952 | 0.793 | 0.723 | 0.763 | 0.776 | 0.735 | 0.660* |
| Focal-R + LDS + FDS + Regularizer | 0.911 | 0.943 | 0.779 | 0.866 | 0.757 | 0.765 | 0.725** | 0.747 |
| RRT | 0.964 | 0.842 | 1.503 | 0.978 | 0.793 | 0.739 | 1.044 | 0.768 |
| RRT + LDS | 0.916 | 0.817 | 1.344 | 0.945 | 0.772 | 0.727 | 0.980 | 0.756 |
| RRT + FDS | 0.929 | 0.857 | 1.209 | 1.025 | 0.769 | 0.736 | 0.905 | 0.795 |
| RRT + LDS + FDS | 0.903 | 0.806* | 1.323 | 0.936 | 0.764 | 0.719* | 0.965 | 0.760 |
| RRT + Regularizer | 0.865** | 0.876 | 0.867 | 0.670** | 0.748** | 0.749 | 0.767 | 0.670* |
| RRT + LDS + Regularizer | 0.874 | 0.893 | 0.833* | 0.722 | 0.754 | 0.758 | 0.752* | 0.698 |
| RRT + FDS + Regularizer | 0.871 | 0.874 | 0.898 | 0.734 | 0.750 | 0.748 | 0.779 | 0.687 |
| RRT + LDS + FDS + Regularizer | 0.882 | 0.892 | 0.887 | 0.702 | 0.758 | 0.759 | 0.775 | 0.681 |
| Inv | 1.005 | 0.894 | 1.482 | 1.046 | 0.805 | 0.761 | 1.016 | 0.780 |
| Inv + LDS | 0.914 | 0.819 | 1.319 | 0.955 | 0.773 | 0.729 | 0.970 | 0.772 |
| Inv + FDS | 0.927 | 0.851 | 1.225 | 1.012 | 0.771 | 0.740 | 0.914 | 0.756 |
| Inv + LDS + FDS | 0.907 | 0.802** | 1.363 | 0.942 | 0.766 | 0.718** | 0.986 | 0.755 |
| Inv + Regularizer | 1.091 | 1.056 | 1.240 | 1.118 | 0.854 | 0.843 | 0.912 | 0.822 |
| Inv + LDS + Regularizer | 0.889* | 0.911 | 0.849* | 0.690* | 0.755* | 0.762 | 0.758* | 0.638** |
| Inv + FDS + Regularizer | 1.083 | 1.035 | 1.301 | 1.063 | 0.831 | 0.812 | 0.914 | 0.840 |
| Inv + LDS + FDS + Regularizer | 0.903 | 0.908 | 0.911 | 0.804 | 0.761 | 0.759 | 0.786 | 0.712 |
| Regularizer (best) vs. Vanilla | +0.109 | −0.023 | +0.753 | +0.314 | +0.046 | −0.008 | +0.318 | +0.133 |
| Regularizer (best) vs. Yang et al. (best) | +0.038 | −0.072 | +0.260 | +0.246 | +0.016 | −0.030 | +0.178 | +0.094 |
| | Metrics | | | | | | | |
| | Pearson cor. (%)↑ | | | | Spearman cor. (%) ↑ | | | |
| Shot | All | Many | Med. | Few | All | Many | Med. | Few |
| Vanilla | 74.2 | 72.0 | 62.7 | 75.2 | 74.4 | 68.8 | 50.5 | 75.0 |
| Vanilla + LDS | 75.6 | 73.4 | 63.8 | 76.2 | 76.1 | 70.4 | 55.6** | 74.3 |
| Vanilla + FDS | 75.5 | 73.0 | 67.0 | 72.8 | 75.8 | 69.9 | 54.4 | 72.0 |
| Vanilla + LDS + FDS | 76.0 | 74.0* | 65.2 | 76.6 | 76.4 | 70.7* | 54.9 | 74.9 |
| Vanilla + Regularizer | 76.8* | 71.0 | 72.9** | 85.2 | 77.2* | 68.3 | 55.4 | 88.4* |
| Vanilla + LDS + Regularizer | 76.2 | 70.7 | 70.0 | 85.6 | 76.3 | 67.8 | 49.0 | 85.4 |
| Vanilla + FDS + Regularizer | 76.5 | 70.4 | 72.5 | 85.7* | 76.7 | 67.1 | 53.5 | 87.8 |
| Vanilla + LDS + FDS + Regularizer | 75.8 | 70.6 | 69.0 | 82.7 | 75.8 | 67.3 | 49.3 | 84.9 |
| Focal-R | 74.6 | 72.3 | 61.8 | 76.4 | 75.0 | 69.4 | 51.9 | 75.5 |
| Focal-R + LDS | 75.7 | 73.9* | 62.4 | 75.4 | 76.2 | 71.2** | 50.7 | 74.7 |
| Focal-R + FDS | 75.1 | 72.6 | 66.4 | 74.7 | 75.4 | 69.4 | 52.7* | 75.4 |
| Focal-R + LDS + FDS | 74.9 | 72.2 | 66.3 | 77.3 | 75.1 | 69.2 | 52.5 | 76.4 |
| Focal-R + Regularizer | 76.2 | 70.8 | 70.4 | 84.6 | 76.7 | 68.2 | 51.0 | 87.7 |
| Focal-R + LDS + Regularizer | 76.7* | 71.2 | 70.3 | 85.1* | 77.1* | 68.2 | 50.1 | 88.4* |
| Focal-R + FDS + Regularizer | 75.6 | 69.6 | 71.5* | 84.8 | 75.8 | 66.9 | 49.7 | 87.7 |
| Focal-R + LDS + FDS + Regularizer | 75.7 | 69.9 | 71.4 | 81.2 | 75.7 | 67.0 | 47.7 | 80.7 |
| RRT | 74.5 | 72.4 | 62.3 | 75.4 | 74.7 | 69.2 | 51.3 | 74.7 |
| RRT + LDS | 75.7 | 73.5 | 64.1 | 76.6 | 76.1 | 70.4 | 53.2 | 74.2 |
| RRT + FDS | 74.9 | 72.1 | 67.2 | 74.0 | 75.0 | 69.1 | 52.8 | 74.6 |
| RRT + LDS + FDS | 76.0 | 73.8* | 65.2 | 76.7 | 76.4 | 70.8* | 54.7* | 74.7 |
| RRT + Regularizer | 77.1** | 72.2 | 68.3 | 86.1** | 77.4** | 69.6 | 48.0 | 89.4** |
| RRT + LDS + Regularizer | 77.0 | 72.3 | 68.3 | 84.8 | 77.2 | 69.5 | 47.2 | 87.8 |
| RRT + FDS + Regularizer | 76.8 | 72.0 | 68.7* | 84.5 | 77.0 | 69.4 | 47.1 | 87.2 |
| RRT + LDS + FDS + Regularizer | 76.6 | 71.7 | 68.0 | 85.5 | 76.8 | 69.0 | 46.5 | 88.3* |
| Inv | 72.8 | 70.3 | 62.5 | 73.2 | 73.1 | 67.2 | 54.1 | 71.4 |
| Inv + LDS | 75.6 | 73.4 | 63.8 | 76.2 | 76.1 | 70.4 | 55.6** | 74.3 |
| Inv + FDS | 75.0 | 72.4 | 66.6 | 74.2 | 75.2 | 69.2 | 55.2 | 74.8 |
| Inv + LDS + FDS | 76.0 | 74.0** | 65.2 | 76.6 | 76.4* | 70.7* | 54.9 | 74.9 |
| Inv + Regularizer | 69.9 | 65.2 | 60.1 | 76.0 | 70.2 | 62.5 | 45.0 | 78.5 |
| Inv + LDS + Regularizer | 76.2* | 70.7 | 70.0* | 85.6* | 76.3 | 67.8 | 49.0 | 85.4* |
| Inv + FDS + Regularizer | 70.0 | 64.8 | 68.9 | 76.7 | 69.7 | 61.6 | 43.8 | 82.5 |
| Inv + LDS + FDS + Regularizer | 75.8 | 70.6 | 69.0 | 82.7 | 75.8 | 67.3 | 49.3 | 84.9 |
| Regularizer (best) vs. Vanilla | +2.9 | +0.3 | +10.2 | +10.5 | +3.0 | +0.8 | +4.9 | +14.4 |
| Regularizer (best) vs. Yang et al. (best) | +1.1 | −1.7 | +5.7 | +8.4 | +1.0 | −1.6 | −0.2 | +13.0 |

Table 3 shows experimental results on the STS-B-DIR benchmark. For three metrics (MSE, MAE, and Pearson correlation), the example regularizer 100 consistently achieves leading performance on the test set overall, as well as in the medium-shot and few-shot categories; the INV+LDS+FDS baseline performs slightly better in the many-shot category. The best overall and few-shot results are obtained by the example regularizer 100 combined with two-stage retraining (RRT): 0.865 mean squared error overall and 0.670 mean squared error in the few-shot setting.

### Ablations and Analysis: Different Choices for the Penalty Function

The regularizer 100 according to at least some example embodiments uses the function [symbol] in Eq. 4 to penalize differences between the ranking of neighbors in label space and the ranking of neighbors in feature space. Mean squared error is adopted in all of the above benchmark experiments. In this ablation experiment, to provide a more complete picture of different ranking similarity losses, several other options for [symbol] are evaluated. Let rk^{a} and rk^{b} denote two m-dimensional ranking vectors of interest. The following options are considered for [symbol]
1. Cosine distance:

$$1 - \frac{r {k}^{a} \cdot {rk}^{b}}{{‖ {rk}^{a} ‖}_{2} \times {‖ {rk}^{b} ‖}_{2}}$$

2. Huber Loss:

$$\frac{1}{m} {Σ}_{i = 1}^{m} {l}_{i} ,$$

with δ default as 1.0,

$${ℓ}_{i} = \{ \begin{matrix}0.5 \times {( r {k}_{i}^{a} - r {k}_{i}^{b} )}^{2} , & if \vert {rk}_{i}^{a} - r {k}_{i}^{b} \vert < δ \\ δ \times ( \vert {rk}_{i}^{a} - r {k}_{i}^{b} \vert - 0. 5 \times δ ) , & otherwise\end{matrix}$$

3. L₂₈ distance: maxᵢ|rkᵢ^{a}−rkᵢ^{b}|
4. MAE:

$$\frac{1}{m} {Σ}_{i = 1}^{m} \vert {rk}_{i}^{a} - r {k}_{i}^{b} \vert$$

5. MSE:

$$\frac{1}{m} {Σ}_{i = 1}^{m} {( r {k}_{i}^{a} - r {k}_{i}^{b} )}^{2}$$

Table 4 presents ablation results on AgeDB-DIR and IMDB-WIKI-DIR with SQINV. On AgeDB-DIR, implementing an example embodiment of the regularizer 100 with any of the above options for [symbol] improves the baseline SQINV. MSE achieves the best performance on the dataset overall, as well as on the many-shot subset. Cosine distance achieves the best performance on the medium-shot and few-shot subsets. On IMDB-WIKI-DIR, cosine distance and MSE achieve comparable best performance overall and in the few-shot subset. Either option consistently improves the baseline SQINV in all settings. In Table 4, results are on AgeDB-DIR (top) and IMDB-WIKI-DIR (bottom) with SQINV, and MSE is used in all other experiments. Best results are marked with an *.

TABLE 4
Different Choices of Ranking Similarity Penalty Function

[symbol]

| | MAE ↓ | | | | GM ↓ | | | |
|---|---|---|---|---|---|---|---|---|
| | All | Many | Med. | Few | All | Many | Med. | Few |
| AgeDB-DIR | | | | | | | | |
| COSINE DISTANCE | 6.99 | 6.55 | 7.61* | 9.47* | 4.40 | 4.14 | 4.84* | 5.95* |
| HUBER | 7.05 | 6.43 | 7.99 | 10.25 | 4.53 | 4.07 | 5.68 | 6.69 |
| L_{∞} | 7.07 | 6.53 | 7.81 | 10.08 | 4.60 | 4.37 | 5.07 | 7.06 |
| MAE | 7.04 | 6.42 | 7.94 | 10.42 | 4.37 | 3.95 | 4.18 | 7.27 |
| MSE | 6.91* | 6.34* | 7.79 | 9.89 | 4.28* | 3.92* | 4.88 | 6.89 |
| IMDB-WIKI-DIR | | | | | | | | |
| COSINE DISTANCE | 7.38* | 6.79* | 12.25 | 21.87* | 4.07* | 3.83* | 7.14 | 13.62 |
| HUBER | 7.46 | 6.87 | 12.22 | 22.87 | 4.17 | 3.94 | 6.87 | 14.07 |
| L_{∞} | 7.57 | 7.01 | 11.99* | 22.28 | 4.29 | 4.08 | 6.54* | 13.59 |
| MAE | 7.48 | 6.86 | 12.50 | 23.13 | 4.14 | 3.89 | 7.07 | 14.79 |
| MSE | 7.42 | 6.84 | 12.12 | 22.13 | 4.10 | 3.87 | 6.74 | 12.78* |

### Ablations and Analysis: Different Choices for the Feature Similarity Function σ^{z}

The similarity function σ^{z} in Eq. 3 quantifies the similarity of two data samples in feature space. The cosine similarity is adopted in all of the benchmark experiments above. Here, an example embodiment of the regularizer 100 with different choices for the feature-space similarity function is evaluated. Let z₁ and z₂ denote two d-dimensional feature vectors. The following options are considered for σ^{z}:
1 Negative L_{∞}: −maxᵢ |z_{1,i}−z_{2,i}|
2. Negative MAE:

$$- \frac{1}{d} {Σ}_{i = 1}^{d} \vert {z}_{1 , i} - {z}_{2 , i} \vert$$

3. Negative MSE:

$$- \frac{1}{d} {Σ}_{i = 1}^{d} {( {z}_{1 , i} - {z}_{2 , i} )}^{2}$$

4. Correlation Similarity:

$$\frac{( {z}_{1} - {\overline{z}}_{1} ) \cdot ( {z}_{2} - {\overline{z}}_{2} )}{{‖ {z}_{1} - {\overline{z}}_{1} ‖}_{2} \times {‖ {z}_{2} - {\overline{z}}_{2} ‖}_{2}}$$

5. Cosine Similarity:

$$\frac{{z}_{1} \cdot {z}_{2}}{{‖ {z}_{1} ‖}_{2} \times {‖ {z}_{2} ‖}_{2}}$$

Table 5 presents ablation results on AgeDB-DIR and IMDB-WIKI-DIR with SQINV. On AgeDB-DIR, implementing an example embodiment of the regularizer 100 with any of the above options for σ^{z} improves the baseline SQINV. Cosine similarity achieves the best performance on the dataset overall, as well as on the many-shot subset. Negative MSE achieves the best performance on the few-shot subset. On IMDB-WIKI-DIR, cosine similarity achieves the best performance overall, in the many-shot subset, and in the few-shot subset. Negative MAE, negative MSE, and cosine similarity consistently improve the baseline SQINV. In Table 5, results are on AgeDB-DIR (top) and IMDB-WIKI-DIR (bottom) with SQINV, and cosine similarity was used in all other experiments. Best results are marked with an *.

TABLE 5
Different Choices of Feature Similarity Function σ^{z}

| | MAE ↓ | | | | GM ↓ | | | |
|---|---|---|---|---|---|---|---|---|
| | All | Many | Med. | Few | All | Many | Med. | Few |
| AgeDB-DIR | | | | | | | | |
| NEGATIVE L_{∞} | 7.14 | 6.56 | 7.92 | 10.37 | 4.51 | 4.15 | 5.11 | 7.05 |
| NEGATIVE MAE | 7.25 | 6.54 | 8.40 | 10.77 | 4.67 | 4.18 | 5.64 | 7.89 |
| NEGATIVE MSE | 7.06 | 6.61 | 7.80* | 9.20* | 4.43 | 4.17 | 4.95 | 5.83* |
| CORRELATION SIMILARITY | 7.32 | 6.77 | 8.24 | 10.01 | 4.75 | 4.43 | 5.37 | 6.44 |
| COSINE SIMILARITY | 6.91* | 6.34* | 7.79 | 9.89 | 4.28* | 3.92* | 4.88* | 6.89 |
| IMDB-WIKI-DIR | | | | | | | | |
| NEGATIVE L_{∞} | 7.44 | 6.85 | 12.10 | 23.33 | 4.15 | 3.92 | 6.61 | 15.14 |
| NEGATIVE MAE | 7.48 | 6.92 | 11.86* | 22.56 | 4.21 | 3.99 | 6.56* | 14.33 |
| NEGATIVE MSE | 7.46 | 6.87 | 12.26 | 22.20 | 4.17 | 3.93 | 6.97 | 14.55 |
| CORRELATION SIMILARITY | 7.78 | 7.03 | 14.09 | 24.97 | 4.26 | 3.93 | 9.00 | 16.59 |
| COSINE SIMILARITY | 7.42* | 6.84* | 12.12 | 22.13* | 4.10* | 3.87* | 6.74 | 12.78* |

### Ablations and Analysis: Ablation on Batch Sampling

As described above, during training, [symbol] is sampled from the current batch such that each label occurs at most once. The intent is to reduce ties and boost the relative representation of infrequent labels. In this ablation, the sampling is removed and the entire batch is used as [symbol] . Table 6 shows the ablation results. Applying sampling leads to better performance in the few-shot and medium-shot regions, and comparable performance overall. In Table 6, “With sampling” refers to sampling [symbol] from the current batch such that each label occurs at most once. Results are on IMDB-WIKI-DIR and AgeDB-DIR with SQINV re-weighting, and STS-B-DIR with Vanilla; sampling is applied in all other experiments. Best results are marked with an *.

TABLE 6
Ablation Study on Batch Sampling

| | MAE↓ | | | | GM↓ | | | |
|---|---|---|---|---|---|---|---|---|
| | All | Many | Med. | Few | All | Many | Med. | Few |
| AgeDB-DIR | | | | | | | | |
| WITH SAMPLING | 6.91* | 6.34* | 7.79* | 9.89* | 4.28* | 3.92* | 4.88* | 6.89* |
| WITHOUT SAMPLING | 7.10 | 6.52 | 7.99 | 10.17 | 4.53 | 4.17 | 5.16 | 6.85 |
| IMDB-WIKI-DIR | | | | | | | | |
| WITH SAMPLING | 7.42* | 6.84* | 12.12* | 22.13* | 4.10* | 3.87* | 6.74* | 12.78* |
| WITHOUT SAMPLING | 7.45 | 6.85 | 12.27 | 23.05 | 4.14 | 3.89 | 7.04 | 15.67 |
| | MSE↓ | | | | Pearson cor. (%)↑ | | | |
| STS-B-DIR | All | Many | Med. | Few | All | Many | Med. | Few |
| WITH SAMPLING | 0.873 | 0.908 | 0.767* | 0.705* | 76.8* | 71.0 | 72.9* | 85.2* |
| WITHOUT SAMPLING | 0.869* | 0.869* | 0.884 | 0.805 | 76.7 | 71.6* | 69.1 | 83.3 |

### Ablations and Analysis: Qualitative Visualization of Feature Space

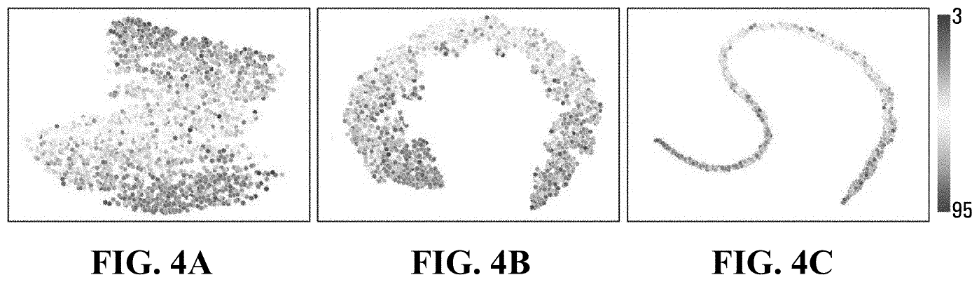

The features from ResNet-50 (Vanilla, Vanilla with FDS, and Vanilla with an example embodiment of the regularizer 100) are extracted on the AgeDB-DIR test set and visualized using t-SNE technique in FIGS. 4A (Vanilla), 4B (Vanilla with FDS), and 4C (Vanilla with an example embodiment of the regularizer 100). The visualization shows the continuity in features learned with FDS and an example embodiment of the regularizer 100. In FIGS. 4A-4C, t-SNE is used by treating the continuous labels (age, from 3 to 95) as categorical (92 “classes”, with no samples of age 4). To visually differentiate labels and show the continuity in feature space, the labels are denoted in greyscale. In FIG. 4A, age generally increases from 3 to 95 from the bottom of the plot to the top, while in FIGS. 4B and 4C age generally increases from 3 to 95 from the left of the plots to the right.

### Ablations and Analysis: Qualitative Visualization of Ranking Matrices with Balanced and Imbalanced Data

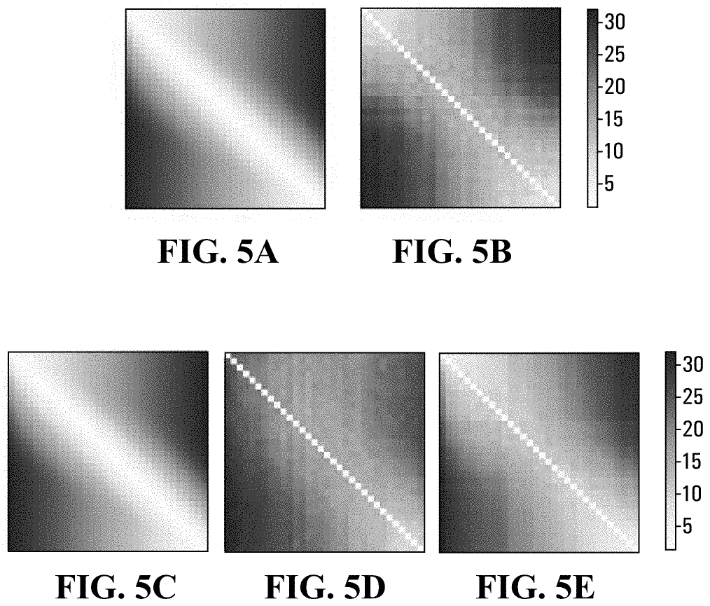

In FIGS. 5A-5E, the average (batch-wise) label-space and feature-space ranking matrices under three training settings are visualized: Vanilla network on balanced data, Vanilla network on imbalanced data, and Vanilla with an example embodiment of the regularizer 100 on imbalanced data. AgeDB-DIR is used for this visualization; for the setting with balanced data, a balanced subset of AgeDB-DIR consisting of the many-shot ages only (ages in the range of 23 to 63) is extracted. For clarity of visualization, samples in each batch are pre-sorted by label (i.e., age). Each batch consists of 32 samples. The visualized matrices are obtained by applying the ranking operation rk on each row of S^{y} and S^{z} as in Eq. 4, and averaging the result over all test batches. More particularly, FIGS. 5A and 5B represent training done with a balanced subset of AgeDB-DIR, with FIG. 5A representing the ranking of S^{y} in label-space and FIG. 5B representing the ranking of S^{z} (Vanilla) in feature-space, while FIGS. 5C-5E represent training with an imbalanced subset of AgeDB-DIR with FIG. 5C representing the ranking of S^{y} in label-space, FIG. 5D representing the ranking of S^{z} (Vanilla) in feature-space, and FIG. 5E representing the ranking of S^{z} (an example embodiment of the regularizer 100) in feature-space.

FIGS. 5A and 5B show that the label-space and feature-space rankings tend to be consistent when training with balanced data. In other words, the sorted list of neighbors in label space tend to resemble the sorted list of neighbors in feature space. This validates the example regularizer's 100 inductive bias. FIGS. 5C-5E show that this pattern disappears when training with imbalanced data. Training with this example embodiment of the regularizer 100 helps to recover the pattern: the sorted list of neighbors in feature space (FIG. 5E) again tends to resemble the sorted list of neighbors in label space (FIG. 5C).

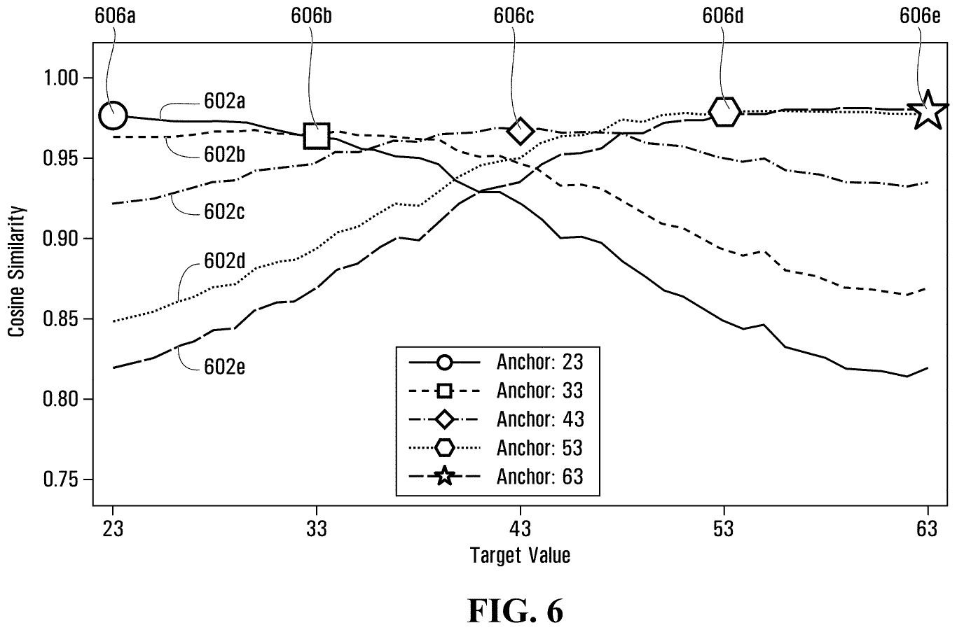

In FIG. 6, the cosine similarity between the Vanilla network features on the balanced subset is plotted. More particularly, FIG. 6 depicts feature cosine similarity learned by Vanilla ResNet-50 from a balanced subset of AgeDB-DIR, with each of the curves 602a-e depicting the feature similarity between the anchor and other labels (x-axis). For example, the point (25, 0.974) on the first curve 602a (anchor 23) indicates the mean feature cosine similarity between age 23 and 25 is 0.974. Each of the points 606a-e is the mean cosine (intra) similarity between the data points of the corresponding anchor value.

The visualization provides an alternative view showing the consistency between label-space neighbors and feature-space neighbors when training on balanced data. For example, the first curve 602a for the youngest anchor shows a roughly monotonic drop in the average feature similarity as x-axis values progress to older ages. The third curve 602c for the middle (age 43) anchor shows roughly monotonic drops in the average feature similarity in both directions as x-axis values progress to younger or older ages. The points 606a-e on the curves 602a-e are the mean cosine similarity between the data instances of the anchor itself (e.g. the first point 606a denotes the mean cosine similarity between all data of age 23). Thus, the points 606a-d usually have highest similarity. FIG. 6 complements FIGS. 5A and 5B, showing from a feature centric view that, in the balanced setting, a Vanilla network naturally learns representations such that items closer in label-space are also closer in feature-space.

### Ablations and Analysis: Zero-Shot Targets

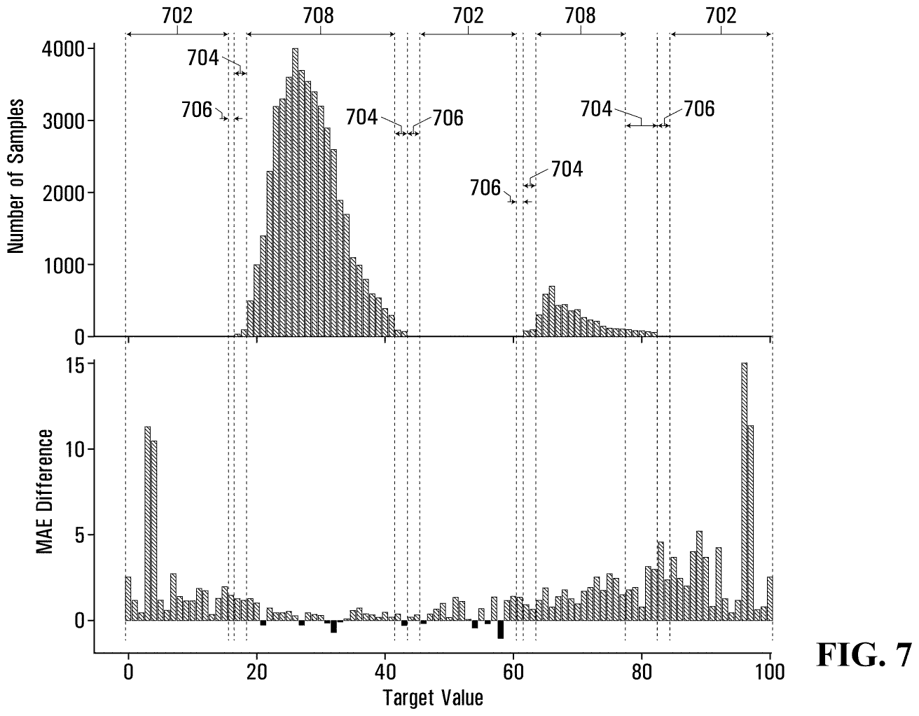

To demonstrate the ability of an example embodiment of the regularizer 100 to handle the zero-shot scenario, a subset of IMDB-WIKI-DIR is constructed that contains zero-shot targets. A top graph of FIG. 7 shows the hand-crafted training distribution, which is intended to imitate the zero-shot experiment construction in Yang et al. A bottom graph of FIG. 7 shows that, in addition to performing comparably with LDS+FDS in or near the many-shot region, the example embodiment of the regularizer 100 significantly outperforms LDS+FDS in the zero-shot region. In the bottom graph of FIG. 7, the zero-shot region is labeled as 702, the medium-shot region is labeled as 704, the few-shot region is labeled as 706, and the many-shot region is labeled as 708. The performance gap is largest for the zero-shot targets at the extremes. The global ranking-driven representation learned by the example regularizer 100 may be effective at both interpolation and extrapolation, while LDS and FDS, as local smoothing-based methods, are primarily designed for interpolation.

More particularly, the top graph of FIG. 7 is a hand-crafted subset of IMDB-WIKI-DIR that has zero-shot targets imitating the zero-shot experiment construction in Yang et al., while the bottom graph of FIG. 7 is the MAE difference (LDS+FDS minus the example regularizer 100) for each target value on the balanced test set. SQINV is applied to re-weight both LDS+FDS and the example regularizer 100. The bottom graph of FIG. 7, positive y-axis values means that the example regularizer 100 performs better.

### Ablations and Analysis: Training Cost

The training time for AgeDB-DIR on four NVIDIA™ GeForce™ GTX™ 1080 Ti GPUs was measured. An example embodiment of the regularizer 100 incurs a small overhead with respect to Vanilla training and is faster to train than FDS: for one epoch, Vanilla takes 12.2 seconds for a forward pass and 31.5 seconds for training; the example regularizer 100 takes 16.8 seconds for a forward pass and 38.8 seconds for training; and FDS takes 38.4 seconds for a forward pass and 60.5 seconds for training.

### Ablations and Analysis: Sensitivity to Hyperparameters

An example embodiment of the regularizer 100 introduces two hyperparameters: the balancing weight γ and the interpolation strength λ. Sensitivity experiments were performed on AgeDB-DIR and IMDB-WIKI-DIR in which these two hyperparameters were varied. Table 7 shows the results of varying hyperparameters in respect of AgeDB-DIR, and Table 8 shows the results of varying hyperparameters in respect of IMDB-WIKI-DIR.

In Table 7, experiments are conducted on AgeDB-DIR with SQINV. In the first section, λ is kept as 2 and γ is changed (the best result is marked with an *). In the second section, γ is kept as 100 and λ is changed (the best result is marked with an *). The best result for each metric in all experiments (i.e., the entire column) is marked with a **.

TABLE 7
Varying Hyperparameters on AgeDB-DIR Experiments

| hyperparams | | MAE ↑ | | | | GM ↑ | | | |
|---|---|---|---|---|---|---|---|---|---|
| γ | λ | All | Many | Med. | Few | All | Many | Med. | Few |
| 0.01 | 2 | 7.42 | 6.75 | 8.42 | 11.01 | 4.76 | 4.31 | 5.63 | 7.59 |
| 0.1 | 2 | 7.36 | 6.72 | 8.44 | 10.42 | 4.72 | 4.31 | 5.58 | 7.00 |
| 1 | 2 | 7.17 | 6.56 | 8.23 | 10.08 | 4.49 | 4.10 | 5.30 | 6.78 |
| 10 | 2 | 7.05 | 6.55 | 7.79* | 9.72 | 4.56 | 4.22 | 5.18 | 6.53 |
| 100 | 2 | 6.91** | 6.34** | 7.79* | 9.89 | 4.28** | 3.92** | 4.88** | 6.89 |
| 200 | 2 | 7.15 | 6.52 | 8.31 | 9.94 | 4.54 | 4.10 | 5.67 | 6.45* |
| 500 | 2 | 7.18 | 6.54 | 8.17 | 10.46 | 4.55 | 4.12 | 5.45 | 7.01 |
| 1000 | 2 | 7.17 | 6.47 | 8.44 | 10.26 | 4.54 | 4.13 | 5.46 | 6.80 |
| 2000 | 2 | 7.10 | 6.50 | 7.99 | 10.27 | 4.50 | 4.08 | 5.35 | 7.06 |
| 3000 | 2 | 7.14 | 6.70 | 7.73 | 9.66* | 4.61 | 4.33 | 4.99 | 6.72 |
| 100 | 0.05 | 7.76 | 7.02 | 9.25 | 10.67 | 4.97 | 4.53 | 6.06 | 6.92 |
| 100 | 0.1 | 7.32 | 6.72 | 8.21 | 10.55 | 4.65 | 4.25 | 5.47 | 6.98 |
| 100 | 0.5 | 7.11 | 6.64 | 7.70** | 9.93 | 4.60 | 4.28 | 5.09 | 6.96 |
| 100 | 1 | 7.26 | 6.63 | 8.31 | 10.24 | 4.63 | 4.18 | 5.64 | 6.93 |
| 100 | 1.5 | 7.07 | 6.45 | 8.22 | 9.79 | 4.47 | 4.06 | 5.40 | 6.66 |
| 100 | 2 | 6.91** | 6.34** | 7.79 | 9.89 | 4.28** | 3.92** | 4.88** | 6.89 |
| 100 | 4 | 7.14 | 6.60 | 7.84 | 10.31 | 4.55 | 4.25 | 5.03 | 6.69 |
| 100 | 8 | 7.26 | 6.85 | 7.82 | 9.61** | 4.68 | 4.42 | 5.10 | 6.36** |
| 100 | 16 | 7.14 | 6.66 | 7.76 | 9.91 | 4.56 | 4.27 | 4.99 | 6.56 |
| 100 | 32 | 7.25 | 6.64 | 8.28 | 10.18 | 4.78 | 4.35 | 5.77 | 7.02 |
| 100 | 64 | 7.11 | 6.51 | 7.90 | 10.69 | 4.55 | 4.10 | 5.47 | 7.19 |

| | |
|---|---|
| hyperparams | MSE ↓ |

| γ | λ | All | Many | Med. | Few |
|---|---|---|---|---|---|
| 0.01 | 2 | 94.68 | 77.19 | 114.39 | 205.43 |
| 0.1 | 2 | 91.86 | 76.50 | 114.43 | 174.48 |
| 1 | 2 | 89.20 | 75.28 | 109.53 | 164.49 |
| 10 | 2 | 84.57 | 72.21 | 99.37* | 155.74 |
| 100 | 2 | 82.10** | 68.60 | 102.61 | 152.84 |
| 200 | 2 | 87.45 | 73.51 | 108.96 | 159.55 |
| 500 | 2 | 88.86 | 73.57 | 110.19 | 174.29 |
| 1000 | 2 | 89.71 | 72.37 | 119.44 | 171.34 |
| 2000 | 2 | 87.23 | 72.98 | 103.97 | 175.56 |
| 3000 | 2 | 86.76 | 75.35 | 102.49 | 151.02** |
| 100 | 0.05 | 103.20 | 83.02 | 140.37 | 191.01 |
| 100 | 0.1 | 91.37 | 76.59 | 110.95 | 176.76 |
| 100 | 0.5 | 86.61 | 74.46 | 99.88 | 164.67 |
| 100 | 1 | 90.42 | 76.13 | 113.52 | 161.46 |
| 100 | 1.5 | 85.11 | 71.15 | 107.27 | 155.61 |
| 100 | 2 | 82.10** | 68.60** | 102.61 | 152.84 |
| 100 | 4 | 87.31 | 73.84 | 102.94 | 171.33 |
| 100 | 8 | 89.91 | 79.06 | 104.37 | 152.39* |
| 100 | 16 | 87.02 | 74.28 | 104.00 | 160.32 |
| 100 | 32 | 87.77 | 73.31 | 107.10 | 170.77 |
| 100 | 64 | 85.06 | 71.60 | 96.55** | 180.44 |

In Table 8, experiments are conducted on IMDB-WIKI-DIR with SQINV. In the second section, γ is kept as 100 and λ is changed (the best result is marked with an *). The best result for each metric in all experiments (i.e., the entire column) is marked with a **.

TABLE 8
Varying Hyperparameters on IMDB-WIKI-DIR Experiments

| hyperparams | | MAE ↓ | | | | GM ↓ | | | |
|---|---|---|---|---|---|---|---|---|---|
| γ | λ | All | Many | Med. | Few | All | Many | Med. | Few |
| 0.01 | 2 | 7.67 | 7.08 | 12.42 | 22.86 | 4.32 | 4.07 | 7.25 | 13.52 |
| 0.1 | 2 | 7.61 | 6.99 | 12.67 | 23.31 | 4.26 | 4.01 | 7.19 | 13.34 |
| 1 | 2 | 7.47 | 6.88 | 12.25 | 22.89 | 4.17 | 3.93 | 7.02 | 14.08 |
| 10 | 2 | 7.43 | 6.83* | 12.22 | 23.19 | 4.16 | 3.93 | 6.80 | 14.50 |
| 100 | 2 | 7.42 | 6.84 | 12.12 | 22.13 | 4.10* | 3.87* | 6.74 | 12.78* |
| 200 | 2 | 7.44 | 6.88 | 11.77* | 22.75 | 4.13 | 3.91 | 6.53 | 14.93 |
| 500 | 2 | 7.43 | 6.87 | 11.96 | 21.76 | 4.14 | 3.92 | 6.61 | 12.89 |
| 1000 | 2 | 7.41* | 6.83* | 12.13 | 21.54* | 4.14 | 3.92 | 6.78 | 13.16 |
| 2000 | 2 | 7.58 | 6.98 | 12.35 | 22.81 | 4.22 | 3.98 | 6.89 | 15.13 |
| 3000 | 2 | 7.48 | 6.91 | 11.95 | 22.65 | 4.15 | 3.94 | 6.35** | 14.14 |
| 100 | 0.05 | 7.41 | 6.87 | 11.72** | 22.22 | 4.15 | 3.92 | 6.67 | 14.57 |
| 100 | 0.1 | 7.41 | 6.84 | 11.89 | 22.34 | 4.11 | 3.89 | 6.60 | 13.32 |
| 100 | 0.5 | 7.37** | 6.82** | 11.76 | 22.05 | 4.05** | 3.83** | 6.43* | 12.71 |
| 100 | 1 | 7.50 | 6.94 | 11.98 | 22.49 | 4.23 | 4.00 | 6.78 | 14.19 |
| 100 | 1.5 | 7.50 | 6.95 | 11.88 | 22.39 | 4.21 | 3.98 | 6.85 | 14.33 |
| 100 | 2 | 7.42 | 6.84 | 12.12 | 22.13 | 4.10* | 3.87 | 6.74 | 12.78 |
| 100 | 4 | 7.60 | 7.03 | 12.19 | 22.78 | 4.28 | 4.06 | 6.83 | 14.45 |
| 100 | 8 | 7.53 | 6.93 | 12.33 | 23.23 | 4.24 | 4.00 | 7.09 | 15.37 |
| 100 | 16 | 7.53 | 6.93 | 12.38 | 23.23 | 4.22 | 3.97 | 7.02 | 15.05 |
| 100 | 32 | 7.62 | 7.09 | 11.93 | 21.51** | 4.33 | 4.12 | 6.64 | 12.58** |
| 100 | 64 | 7.65 | 7.09 | 12.05 | 23.02 | 4.31 | 4.08 | 6.78 | 15.41 |

| | |
|---|---|
| hyperparams | MSE ↓ |

| γ | λ | All | Many | Med. | Few |
|---|---|---|---|---|---|
| 0.01 | 2 | 129.26 | 105.88 | 302.88 | 851.47 |
| 0.1 | 2 | 127.55 | 102.95 | 311.63 | 876.28 |
| 1 | 2 | 125.15 | 101.97 | 295.09 | 859.42 |
| 10 | 2 | 123.81 | 99.98 | 300.47 | 862.53 |
| 100 | 2 | 123.76 | 101.02 | 296.73 | 793.55 |
| 200 | 2 | 124.68 | 102.11 | 290.17* | 838.68 |
| 500 | 2 | 123.78 | 101.25 | 295.44 | 785.79 |
| 1000 | 2 | 122.67** | 99.85** | 299.33 | 769.95** |
| 2000 | 2 | 127.88 | 103.97 | 306.62 | 856.13 |
| 3000 | 2 | 126.39 | 103.21 | 298.52 | 842.27 |
| 100 | 0.05 | 124.49 | 102.49 | 284.39** | 831.26 |
| 100 | 0.1 | 124.32 | 101.87 | 289.18 | 833.23 |
| 100 | 0.5 | 124.36 | 101.88 | 289.72 | 831.52 |
| 100 | 1 | 124.39 | 102.01 | 287.93 | 836.41 |
| 100 | 1.5 | 126.34 | 104.34 | 287.73 | 821.28 |
| 100 | 2 | 123.76* | 101.02* | 296.73 | 793.55* |
| 100 | 4 | 128.59 | 105.64 | 297.42 | 850.14 |
| 100 | 8 | 125.32 | 101.61 | 300.69 | 863.02 |
| 100 | 16 | 126.81 | 103.04 | 302.43 | 867.96 |
| 100 | 32 | 127.07 | 105.14 | 290.92 | 796.45 |
| 100 | 64 | 128.65 | 106.24 | 292.17 | 844.65 |

Performance is relatively robust to both γ and λ. Since the example regularizer 100 uses a batch-wise calculation to construct the pairwise similarity matrices, additional sensitivity experiments were conducted in which the batch size was varied. These results are shown in Table 9, in which experiments were conducted on AgeDB-DIR with SQINV re-weighting with λ as 2 and γ as 100. Best results are marked with an *. The regularizer 100 according to the example embodiment used for the experiment is denoted “Regularizer” in the leftmost column of the table.

TABLE 9
Varying AgeDB-DIR Batch Size

| | Metrics | | | | | | | |
|---|---|---|---|---|---|---|---|---|
| | MAE ↓ | | | | GM ↓ | | | |
| Shot | All | Many | Med. | Few | All | Many | Med. | Few |
| VANILLA | 7.77 | 6.62 | 9.55 | 13.67 | 5.05 | 4.23 | 7.01 | 10.75 |
| SQINV + LDS + FDS | 7.55 | 7.01 | 8.24 | 10.79 | 4.72 | 4.36 | 5.45 | 6.79 |
| SQINV + REGULARIZER, | 6.91* | 6.34* | 7.79* | 9.89 | 4.28* | 3.92* | 4.88* | 6.89 |
| batch size 64 | | | | | | | | |
| SQINV + REGULARIZER, | 7.13 | 6.58 | 8.07 | 9.79* | 4.40 | 3.95 | 5.38 | 7.02 |
| batch size 128 | | | | | | | | |
| SQINV + REGULARIZER, | 7.17 | 6.63 | 7.98 | 10.06 | 4.53 | 4.18 | 5.24 | 6.38* |
| batch size 256 | | | | | | | | |

| | Metrics | | | |
|---|---|---|---|---|
| | MSE ↓ | | | |
| Shot | All | Many | Med. | Few |
| VANILLA | 101.60 | 78.40 | 138.52 | 253.74 |
| SQINV + LDS + FDS | 99.46 | 84.10 | 112.20 | 209.27 |
| SQINV + REGULARIZER, | 82.10* | 68.60* | 102.61* | 152.84* |
| batch size 64 | | | | |
| SQINV + REGULARIZER, | 88.93 | 76.68 | 106.52 | 156.00 |
| batch size 128 | | | | |
| SQINV + REGULARIZER, | 89.37 | 75.73 | 105.36 | 173.92 |
| batch size 256 | | | | |

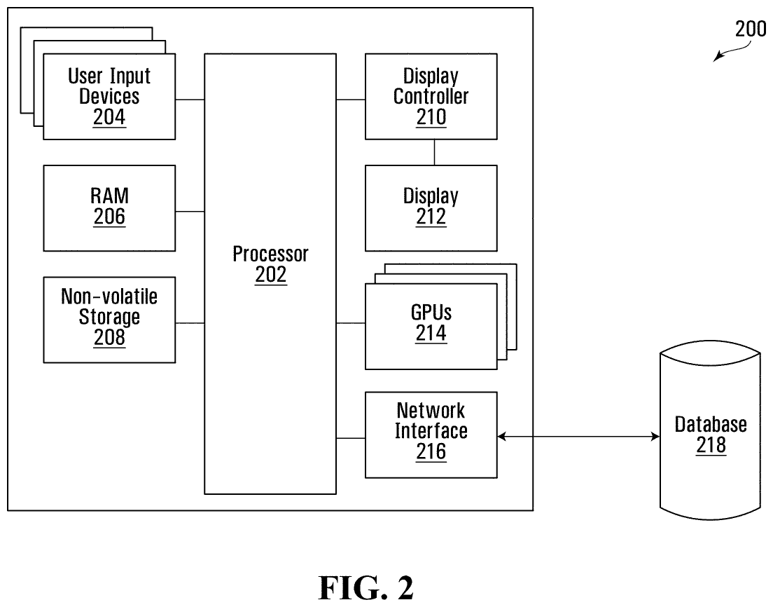

Referring now to FIG. 2, there is shown a block diagram of an example computer system 200 that can be used to implement the example regularizer 100 as described above. More particularly, the computer system 200 may be used for both training and testing/inference. The computer system 200 comprises a processor 202 that controls the system's 200 overall operation. The processor 202 is communicatively coupled to and controls subsystems comprising user input devices 204, which may comprise any one or more user input devices such as a keyboard, mouse, touch screen, and microphone; random access memory (“RAM”) 206, which stores computer program code that is executed at runtime by the processor 202; non-volatile storage 208 (e.g., a solid state drive or magnetic spinning drive), which stores the computer program code loaded into the RAM 204 for execution at runtime and other data; a display controller 210, which may be communicatively coupled to and control a display 212; graphical processing units (“GPUs”) 214, used for parallelized processing as is not uncommon in machine learning applications; and a network interface 216, which facilitates network communications with a network and other devices that may be connected thereto, such as a database 218. Any one or more of the methods for training or applying the example regularizer 100 as described herein may be implemented as computer program code and stored in the non-volatile storage 208 for loading into the RAM 206 and execution by the processor 202, thereby causing the system 200 to calibrate a neural network.

The database 218 that is communicatively coupled to the processor 202 via the network interface 216 may be used to store one or more datasets for training and/or testing/inference, such as the datasets described above in respect of Tables 1-3.

The processor 202 may comprise any suitable processing unit such as a processor, microprocessor, artificial intelligence accelerator, or programmable logic controller, or a microcontroller (which comprises both a processing unit and a non-transitory computer readable medium), or system-on-a-chip (SoC). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method comprising:
(a) obtaining a regression dataset comprising multiple pairs, wherein the pairs respectively comprise inputs and corresponding targets, and wherein the inputs are represented in a feature space and the targets are represented in a label space of continuous values;
(b) determining label space similarities between the targets as represented in the label space;
(c) determining feature space similarities between the inputs as represented in the feature space;
(d) determining a loss based on differences between the label space similarities and feature space similarities that correspond to each other, wherein the loss is based on differences between rankings of the label space similarities and rankings of the feature space similarities; and
(e) training an artificial neural network based on the loss.

2. The method of claim 1, wherein the label space similarities are represented as a first pairwise similarity matrix obtained by applying a first similarity function in the label space across the targets, and wherein the feature space similarities are represented as a second pairwise similarity matrix obtained by applying a second similarity function in the feature space across the inputs.

3. The method of claim 2, wherein the first and second similarity functions differ.

4. The method of claim 3, wherein the first similarity function comprises negative absolute distance and the second similarity function comprises a cosine similarity.

5. The method of claim 1, wherein the loss based on the differences between the label space similarities and feature space similarities is determined as [symbol] , wherein [symbol] comprises
$${\sum }_{i = 1}^{m} ℓ ( rk ( {S}_{[ i , : ]}^{y} ) , rk ( {S}_{[ i , : ]}^{z} ) ) ,$$
wherein S^{y} denotes the first pairwise similarity matrix, S^{z} denotes the second pairwise similarity matrix, [i, :] denotes an ith row of the matrices, rk denotes a ranking function, and [symbol] penalizes differences between the pairwise similarity matrices.

6. The method of claim 5, wherein [symbol] determines mean squared error between rk(S_{[i,:]}^{y}) and rk(S_{[i,:]}^{z}).

7. The method of claim 5, wherein training the artificial neural network comprises determining,
$$\frac{\partial ℒ}{\partial a} = - \frac{1}{λ} ( r k ( a ) - r k ( {a}_{λ} ) ) ,$$
wherein
$${a}_{λ} = a + λ \frac{\partial ℒ}{\partial r k} ,$$
and wherein λ denotes interpolation strength and a denotes S_{[i,:]}^{y} or S_{[i,:]}^{z}.

8. The method of claim 1, wherein the artificial neural network is trained based on minimizing the loss.

9. The method of claim 1, wherein the regression dataset is imbalanced.

10. The method of claim 1, wherein the artificial neural network is trained based on a total loss determined from the loss based on the differences between the label space similarities and feature space similarities and also from one or more additional losses respectively determined by applying one or more imbalanced learning techniques.

11. The method of claim 10, wherein the one or more imbalanced learning techniques comprise any one or more of re-weighting, two-stage training, and distribution smoothing.

12. The method of claim 1, further comprising, after the training:
(a) obtaining a data point of a type corresponding to the feature space; and
(b) applying the artificial neural network to determine a label corresponding to the label space based on the data point.

13. An artificial neural network trained according to a method comprising:
(a) obtaining a regression dataset comprising multiple pairs, wherein the pairs respectively comprise inputs and corresponding targets, and wherein the inputs are represented in a feature space and the targets are represented in a label space of continuous values;
(b) determining label space similarities between the targets as represented in the label space;
(c) determining feature space similarities between the inputs as represented in the feature space;
(d) determining a loss based on differences between the label space similarities and feature space similarities that correspond to each other, wherein the loss is based on differences between rankings of the label space similarities and rankings of the feature space similarities; and
(e) training the artificial neural network based on the loss.

14. The method of claim 13, wherein the label space similarities are represented as a first pairwise similarity matrix obtained by applying a first similarity function in the label space across the targets, and wherein the feature space similarities are represented as a second pairwise similarity matrix obtained by applying a second similarity function in the feature space across the inputs.

15. The method of claim 14, wherein the first and second similarity functions differ, and wherein the first similarity function comprises negative absolute distance and the second similarity function comprises a cosine similarity.

16. The method of claim 13, wherein the loss based on the differences between the label space similarities and feature space similarities is determined as [symbol] , wherein [symbol] comprises
$${\sum }_{i = 1}^{m} ℓ ( rk ( {S}_{[ i , : ]}^{y} ) , rk ( {S}_{[ i , ; ]}^{z} ) ) ,$$
wherein S^{y} denotes the first pairwise similarity matrix, S^{z} denotes the second pairwise similarity matrix, [i, :] denotes an ith row of the matrices, rk denotes a ranking function, and [symbol] penalizes differences between the pairwise similarity matrices,
wherein [symbol] determines mean squared error between rk(S_{[i,:]}^{y}) and rk(S_{[i,:]}^{z}), and wherein training the artificial neural network comprises determining,
$$\frac{\partial ℒ}{\partial a} = - \frac{1}{λ} ( r k ( a ) - r k ( {a}_{λ} ) ) ,$$
wherein
$${a}_{λ} = a + λ \frac{\partial L}{\partial r k} ,$$
and wherein λ denotes interpolation strength and a denotes S_{[i,:]}^{y} or S_{[i,:]}^{z}.

17. The method of claim 13, wherein the regression dataset is imbalanced.

18. The method of claim 13, wherein the artificial neural network is trained based on a total loss determined from the loss based on the differences between the label space similarities and feature space similarities and also from one or more additional losses respectively determined by applying one or more imbalanced learning techniques.

19. The method of claim 18, wherein the one or more imbalanced learning techniques comprise any one or more of re-weighting, two-stage training, and distribution smoothing.

20. A system comprising:
(a) a processor;
(b) a database storing a regression dataset comprising multiple pairs and that is communicatively coupled to the processor; and
(c) a memory that is communicatively coupled to the processor and that has stored thereon computer program code that is executable by the processor and that, when executed by the processor, causes the processor to perform a method comprising:
(i) obtaining the regression dataset from the database, wherein the pairs respectively comprise inputs and corresponding targets, and wherein the inputs are represented in a feature space and the targets are represented in a label space of continuous values;
(ii) determining label space similarities between the targets as represented in the label space;
(iii) determining feature space similarities between the inputs as represented in the feature space;
(iv) determining a loss based on differences between the label space similarities and feature space similarities that correspond to each other, wherein the loss is based on differences between rankings of the label space similarities and rankings of the feature space similarities; and
(v) training an artificial neural network based on the loss.
